(19) United States
(12) Patent Application Publication
(10) Pub. No.: US 2026/0260938 A1
(43) Pub. Date: Sep. 3, 2026

(54) High Cycle-Life Lithium-Ion Cells with Nano-Structured Silicon Comprising Anodes

(71) Applicant: LeydenJar Technologies B.V., Leiden (NL)

(72) Inventor: Ashley Cooke, Leiden (NL)

(73) Assignee: LeydenJar Technologies B.V., Leiden (NL)

(21) Appl. No.: 18/879,553

(22) PCT Filed: Jul. 4, 2023
(86) PCT No.: PCT/NL2023/050362

§ 371 Date: Dec. 27, 2024

(30) Foreign Application Priority Data
Jul. 4, 2022 (NL) 2032368

(51) Int. Cl. H01M 10/0567; H01M 4/02; H01M 4/04; H01M 4/38; H01M 10/0525; H01M 10/0569

(52) U.S. Cl. CPC H01M 10/0567; H01M 4/0447; H01M 4/386; H01M 10/0525; H01M 10/0569; H01M 2004/021; H01M 2004/027; H01M 2300/0028

(57) ABSTRACT

The present application concerns a lithium-ion cell comprising: a silicon anode, the silicon anode comprising: a current collector layer; and a silicon layer, wherein the silicon layer comprising a plurality of columnar structures on a current collector; a cathode; a separator; and an electrolyte, the electrolyte comprising: 9 to 29 wt. %, with respect to the electrolyte, of a lithium salt; a non-aqueous solvent; and a diluent, wherein the electrolyte having a lithium salt-solvent-diluent molar ratio of 1:x:y, where 1.0≤x≤3 and 2.0≤y≤4.0.

### FIELD OF THE INVENTION

The present invention relates lithium-ion cells and batteries of such cells, which comprise: (i) a silicon anode, the silicon anode comprising: a silicon layer; the silicon layer comprising a plurality of columnar structures on a current collector; and (ii) an electrolyte, the electrolyte comprising lithium salts, non-aqueous solvents and diluents.

### BACKGROUND OF THE INVENTION

A battery is a device consisting of one or more electrochemical cells with external connections that convert stored chemical energy into electrical energy. A cell has a positive electrode and a negative electrode, also termed respectively a cathode and an anode. When a battery is connected to an external circuit electrons flow from the anode to the cathode through the external circuit thereby delivering electrical energy to the circuit and any devices connected to the circuit.

Primary batteries such as alkaline batteries are one-time-use batteries as the electrode material changes permanently during discharge. Secondary batteries such as lithium-ion batteries can be charged and discharged multiple times as the original composition of the electrode material can be restored by applying a reverse current.

A cell is made up of two half-cells connected in series by a conductive electrolyte material.

One of the half-cells contains the cathode, while the other half-cell contains the anode with the electrolyte present in both half-cells. A separator may be present between both half-cells. A separator prevents shorting between the cathode and anode, whilst still allowing ions to move across the separator between the two half-cells.

A particularly advantageous type of electrochemical cell is a lithium-ion cell. In lithium ion cells, lithium ions move from the negative electrode, or anode, through an electrolyte to the positive electrode, or cathode, during discharge and back during charging. Lithium ion cells have historically employed an intercalated lithium compound at the positive electrode and graphite at the negative electrode. Lithium ion cells generally possess higher energy density than conventional lead-acid batteries, advantageously do not possess a memory effect and typically exhibit low self-discharge. An example for electrolytes useful for lithium ion cells is for instance disclosed in US-A-2018254524.

Recent developments in lithium ion cells have sought to employ silicon in the anode material in place of the historically used graphite. This is because silicon allows much higher maximum capacities to be realised than the maximum capacity of approximately 370 mAh/g obtainable with graphite. For example, pristine silicon allows for a specific capacity of approximately 3600 mAh/g to be realised. Obtaining higher charge capacity without greatly increasing weight is a key challenge for improving the battery life of mobile phones, drones or electric cars.

A factor that has slowed the widespread commercialisation of lithium-ion cells with anodes that comprise silicon is that silicon typically exhibits a large volume change on lithium insertion, with an increase of up to 300 to 400% in volume possible. Such changes in volume typically cause large anisotropic stresses within the anode, which can lead to fracturing, crumbling or delamination of silicon material from the anode. Fracturing, crumbling or delamination of the silicon material from the anode reduce the charge capacity of the anode and reduce the charge cycle life of a cell comprising such an anode.

To overcome these swelling issues, a range of three-dimensional silicon surface morphologies have been developed for use in anodes. One approach is to develop so-called nanostructured architectures, with examples including three-dimensional thin-films, nanowires and nanotubes. Three-dimensional thin-film silicon anodes employ a geometry most similar to traditional thin-film batteries, in which a thin film of silicon deposited onto a metallic foil, in which the metallic foil serves as a current collector. Thin film “two dimensional” batteries are typically restricted to a film depth of between 2 and 5 micrometres to avoid cracking, crumbling and/or delamination of the silicon layer, limiting areal capacity to significantly less than that obtainable by three-dimensional thin-films. Three-dimensional thin-films use the third dimension, corresponding to depth, to increase the electrochemically active area. An example for such a cell is are for instance disclosed in US-A-2007031744.

One option to do this is to etch perforations into film of silicon by inductive coupled plasma etching on silicon. Another option is to deposit silicon by plasma enhanced chemical vapour deposition in such a way that a thin film of silicon is deposited on the metallic current collecting foil, in which the thin film is mostly formed of columns of silicon extending perpendicular to the metal foils surface. Such columns typically possess a diameter of a few hundred nanometres. Between the columns, but also within the columns are a network of voids, or empty spaces. These nanostructured surface morphologies allow the columns to swell, that is to say increase in volume, and thereby extend into the voids. This means that little to no pressure is exerted by one column on an adjacent column on swelling, meaning that in aggregate, the bulk silicon material exerts little to no pressure parallel to the surface of the metal foil. This advantageously allows these materials with a nanostructured surface morphology to avoid cracking, crumbling or delamination.

A different strategy is structuring the silicon in the form of nanostructures such as nanoparticles, nanowires, nanotubes or more complex 3D structures. Through these nanostructures the silicon is provided with ample space to accommodate volume expansion, reducing internal stress and fractures, while also maintaining a high surface area for lithium-ion transport from electrolyte to silicon. For example, WO2010129910A2 discloses a conductive substrate and silicon containing nanowires substrate-rooted to the conductive substrate. WO2015175509A1 expands upon this concept by having two layers of silicon material coating a nanowire template rooted to the substrate, wherein the second silicon layer has a higher density than the first layer. WO2015175509A1 states that hereby the first silicon layer provides space into which the silicon can expand as it absorbs lithium, while the second silicon layer reduces SEI layer formation.

One such example would be silicon nanowires grown on a steel current collector substrate by a vapour-liquid solid growth method. The wires are attached at one end to the current collector material, and an irregular network of silicon wires is believed to allow for accommodation of large strains on swelling due to incorporation of lithium. This advantageously allows these materials with a nanostructured surface morphology to avoid cracking, crumbling or delamination.

Overall these silicon-containing anodes with three-dimensional morphologies have comparatively high surface areas of the anode in contact with the electrolyte. This is advantageous on one hand as they reduce local current density.

On the first charge-discharge cycle of lithium-ion cell operation, the electrolyte decomposes to form a range of typically ill-defined lithium-containing compounds on the anode surface, producing a layer called the solid-electrolyte interphase (SEI). The solid-electrolyte interphase layer is a result of the reduction potential of the anode. During charge, decreasing potentials at the anode lead to electrochemical reduction of some of the components of the electrolyte at the surface. As the SEI layer is partially formed from lithium comprising compounds, production of SEI growth reduces the total charge capacity of the cell by consuming some of the lithium that could otherwise be used to store charge. This is a degradation mechanism known as Loss of Lithium Inventory (LLI). The properties and evolution of the solid-electrolyte interphase layer fundamentally affects the overall performance of the lithium-ion cell. Reasons for this include: (i) that the solid-electrolyte interphase layers (im)permeability to lithium ions can limit the rate and/or amount of lithium that the anode can store; and (ii) that the solid-electrolyte interphase layers electronic resistivity affects the rate at which the solid-electrolyte interphase layer grows. Typically, the more electronically conductive that the formed SEI layer is, the faster further electrolyte decomposition is and consequently the faster the SEI layer grows. SEI layer growth increases the Loss of Lithium Inventory (LLI).

In a lithium-ion cell with a silicon-comprising anode, the SEI plays an especially important role in capacity degradation, due to the large volumetric changes during cycling. Expansion and contraction of the anode material typically cracks the SEI layer that has formed on top of it, exposing more of the anode material to direct contact with the electrolyte, which results in further SEI production and further LLI. This decreases the commercially useful charge cycle life-span of lithium-ion cells with a silicon-comprising anode. This problem of cracking of the SEI can be particularly acute for anodes comprising silicon with a nanostructured surface morphology, due to the surface area and shapes of silicon material at the anode-electrolyte interphase.

A goal of the disclosure of the present application is to provide a lithium-ion cell comprising an anode, in which the anode comprises silicon, with enhanced specific capacity and charge-cycle stability.

### SUMMARY OF THE DISCLOSURE

In view of the above discussion, a first aspect of the present disclosure relates to a lithium-ion cell comprising:
a silicon anode, comprising:
   i. a current collector layer; and
   ii. a silicon layer positioned on the current collector layer,
      wherein the silicon layer comprising a plurality of columnar structures on a current collector;
a cathode;
a separator; and
an electrolyte, comprising:
   i. of from 9 to 29 wt. %, with respect to the electrolyte, of a lithium salt;
   ii. a non-aqueous solvent; and
   iii. a diluent,
      wherein the electrolyte has a lithium salt-solvent-diluent molar ratio of 1:x:y, wherein x is in the range of from 1.0 to 3.0, and y is in the range of from 2.0 to 4.0.

A further aspect of the present disclosure relates to a lithium-ion cell produced by a process comprising the following steps:
(i) providing of a lithium-ion cell according to the invention;
(ii) charging the cell to a voltage of at least 4.0 V;
(iii) discharging the voltage to 3.0 V.

Another aspect of the present disclosure is a lithium-ion cell produced by a process comprising the following steps:
(i) providing a lithium-ion cell according to the invention;
(ii) charging the cell at 0.01 C for 10 hours;
(iii) charging the cell at 0.1 C for either (i) 9 hours or (ii) until reaching 4.2 V;
(iv) discharging at 0.1 C until reaching 2.5 V;
(v) charging at 0.2 C until reaching 4.2 V;
(vi) discharging at 0.2 C until reaching 2.5 V; and
(vii) charging at 0.2 C for 90 minutes.

Another aspect of the present disclosure relates to a lithium-ion cell comprising:
a silicon anode comprising:
   i. a current collector layer;
   ii. a silicon layer on the current collector layer; and
   iii. a solid electrolyte interphase layer,
      wherein the silicon layer comprises:
i. a plurality of columnar structures on a current collector;
ii. primary voids having a width of from 1 to 10 μm; and
iii. optionally, secondary voids having a width of from 10 to 150 nm;
   a cathode;
   a separator; and
an electrolyte comprising:
   i. a lithium salt;
   ii. a non-aqueous solvent; and
   iii. a diluent.

In another aspect, the present disclosure relates to a battery comprising a lithium-ion cell according to any preceding aspect. Another aspect of the present disclosure is the use of a lithium-ion cell according to any previous aspect as an energy storage and/or release device.

A further aspect of the present disclosure relates to an electrolyte comprising:
9 to 29 wt. % lithium bis(fluorosulfonyl)imide;
1,2-dimethoxyethane; and
1,1,2,2-tetrafluoroethyl 2,2,3,3-tetrafluoropropyl ether,
   the electrolyte having a (lithium bis(fluorosulfonyl)imide):(1,2-dimethoxyethane): (1,1,2,2-tetrafluoroethyl 2,2,3,3-tetrafluoropropyl ether) molar ratio of 1:x:y, wherein 1.3≤x≤3.0 and 2.0≤y≤4.0. Cells and batteries according to the disclosure provided an unexpected and exceptional cycle-life and capacity properties.

### SHORT DESCRIPTION OF THE FIGURES

FIG. 1 depicts schematically and in block diagram form a traditional silicon anode material in a first un-lithiated state (top), a fully lithiated state (middle) and a fully de-lithiated state (bottom)

FIG. 2 depicts schematically a traditional silicon anode material during SEI formation silicon anode material in a first un-lithiated state (top), a fully lithiated state (middle) and a fully de-lithiated state (bottom).

FIG. 3 depicts schematically a silicon anode material in which the silicon layer comprises a plurality of columnar structures on a current collector. It depicts the silicon anode material silicon anode material in a first un-lithiated state (top), a fully lithiated state (middle) and a fully de-lithiated state (bottom).

FIG. 4 depicts schematically a silicon anode material in which the silicon layer comprises (i) a plurality of columnar structures on a current collector and (ii) a SEI. It depicts the silicon anode material silicon anode material in a first un-lithiated state (top), a fully lithiated state (middle) and a fully de-lithiated state (bottom).

FIG. 5 depicts schematically a silicon anode material in a lithium cell according to the invention. It depicts the silicon anode in a first un-lithiated state (top), a fully lithiated state (middle) and a fully de-lithiated state (bottom).

FIGS. 6A and 6B depict scanning electron microscopy images (FIG. 6A top-down view, 6B cross-sectional) obtained of an anode comprising a silicon layer in which the silicon layer comprises a plurality of columnar structures.

FIG. 7A is graph of areal capacity (mAh/cm²) against cycle number experimentally obtained for a material according to the present disclosure (Example 3) and a comparative example (Example 3A).

FIG. 7B is a graph of capacity retention (%) against cycle number experimentally obtained for a material according to the present disclosure (Example 3) and a comparative example (Example 3A).

FIG. 7C is a graph of accumulated specific capacity (Ah/g) against cycle number experimentally obtained for a material according to the present disclosure (Example 3, straight, solid line) and a comparative example (Example 3A, curved, solid line).

FIG. 8A is a graph of capacity retention (%) against cycle number experimentally obtained for a material according to the present disclosure (Example 6, top line) and a comparative example (Example 6A, lower line).

FIG. 8B is a graph of coulombic efficiency (%) against cycle number experimentally obtained for a material according to the present disclosure (Example 6, top line) and a comparative example (Example 6A, bottom line).

FIG. 9A is a SEM image of the anode surfaces of Example 3 (left) and Comparative Example 3A (right) after performing method 6, at 0% state of charge.

FIG. 9B is a SEM image of the anode surface of Example 3(left) and Comparative Example 3A (right) after performing method 6, at 50% state of charge.

### DEFINITIONS AND ABBREVIATIONS

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein. While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.”

As used herein “another” can mean at least a second or more. The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, and those that do not materially affect the basic and novel characteristic(s) of the claimed subject matter. Unless otherwise indicated, all numbers expressing quantities of size, capacity, percentage (%), and so forth used in the specification and claims are to be understood as being modified in all instances by the term “about”.

Accordingly, unless indicated to the contrary, the numerical parameters set forth in this specification and attached claims are approximations that can vary depending upon the desired properties sought to be obtained by the presently disclosed subject matter.
Additive: As used herein, the term Additive refers to a component of an electrolyte that is present in an amount of from 0.01 to 10 wt. %.
Amorphous silicon: The term “amorphous silicon” herein is understood to comprise protocrystalline silicon, which is a definition for amorphous silicon-comprising a fraction of nanocrystalline silicon. This fraction may be up to about 30% of the silicon layer. For ease of reference the term amorphous silicon will be used herein to indicate that the silicon layer comprises amorphous silicon, in which nano-crystalline regions of the silicon layer may be present with a fraction of nanocrystalline silicon up to about 30%.
Anode: The term “Anode” herein is understood as an electrode through which electric charge flows into an electronic device. In the context of the electro-chemical perspective, anions, i.e. negatively charged ions, move toward the anode and/or cations, i.e. positively charged ions, move away from the anode to balance the electrons leaving the electrode to the electronic device. In a discharging lithium-ion battery or galvanic cell, the anode is the negative terminal from which electrons flow out. In a charging or recharging lithium-ion battery, the anode becomes the positive terminal into which electrons flow from the electronic device.
Capacity: The term “capacity” of a battery or cell herein is understood as the amount of electrical charge such a device can deliver. Capacity is expressed in units of mAh or Ah, and indicates the maximum constant current that a battery or cell can produce over an hour. For example, a battery with a capacity of 1 Ah can deliver 1 A for one hour or a current of 100 mA for 10 hours.
Cathode: The term “electrode” herein is understood as an electrode through which electric charge flows out of an electronic device. In the context of the electro-chemical perspective, anions (negatively charged ions) move away from the anode and/or cations (positively charged ions) move towards the anode to balance the electrons entering the electrode from the electronic device. In a discharging lithium ion battery or galvanic cell, the cathode is the positive terminal into which electrons flow. In a charging or recharging lithium ion battery, the cathode becomes the negative terminal out of which electrons flow to the electronic device.
Cell: The term “cell” herein is understood as an electro-chemical device used for generating a voltage or current from a chemical reaction, or the reverse in which an applied current induces a chemical reaction.
Coulombic Efficiency (CE): The term “Coulombic Efficiency” herein is understood as the efficiency with which charge is transferred in a cell or battery. Coulombic efficiency may be defined as the amount of charge exiting the cell or battery during the discharge cycles divided by the amount of charge entering the cell or battery during the previous charging cycle.
DME Herein Represents 1,2-dimethoxyethane
DEC herein represents diethyl carbonate
Doping: The term “doping” is herein understood to mean introducing a trace of an element into a material to alter the original electrical properties of the material or to improve the crystal structure of the silicon material.
EC herein represents ethylene carbonate
Electrolyte herein represents a substance comprising free ions that behaves as an ionically conductive medium. In the context of the disclosures herein, electrolytes comprise ions in a solution.
FEC herein represents Fluoroethylene carbonate.
Fluoroalkyl herein represents an alkyl group wherein at least one C—H bond has been replaced with a C—F bond.
Fluoroalkyl ether: in the context of the disclosures herein, the term refer to a fluorinated ether having a general formula R¹—O—R², wherein at least one of R¹ and R² is independently selected from a fluoroalkyl. The fluoroalkyl chain may be straight chain, cyclic or branched. The fluoroalkyl ether may be partially or fully fluorinated. R¹ and R² may be the same of different from each other.
LiFSI herein represents lithium bis(fluorosulfonyl)imide.
Perfluoroalkyl group herein represents an alkyl group in which all C—H bonds have been replaced with C—F bonds.
Silicon anode herein represents a silicon anode is an anode in which the majority of the mass is silicon, preferably at least 60 wt. %, more preferably at least 70 wt. % and most preferably at least 80 wt. %.
Specific areal capacity: herein represents the capacity per unit of area of the electrode or active material. The units of specific areal capacity are mAh/cm².
Specific capacity herein represents the capacity per unit mass. In this patent, the mass specifically refers to the mass of silicon active material in the anode. Specific capacity may be expressed in units of mAh/g.
Solid Electrolyte Interphase (SEI) herein represents a passivation layer comprising decomposition materials arising from the electrochemical decomposition of the electrolyte at the electrode/electrolyte phase boundary of the anode. This is typically formed in during the first few cycles of a lithium ion battery or cell.
TTE herein represents 1,1,2,2-tetrafluoroethyl-2,2,3,3-tetrafluoropropyl ether.

### DETAILED DESCRIPTION OF THE INVENTION

### Lithium-Ion Cell

The present disclosure is directed to a lithium-ion cell comprising:
a silicon anode, the silicon anode comprising:
   i. a current collector layer; and
   ii. a silicon layer,
      wherein the silicon layer comprising a plurality of columnar structures on a current collector;
a cathode;
a separator; and
an electrolyte, the electrolyte comprising:
   i. 9 to 29 wt. %, with respect to the electrolyte, of a lithium salt;
   ii. a non-aqueous solvent; and
   iii. a diluent,
      wherein the electrolyte having a lithium salt-solvent-diluent molar ratio of 1:x:y, where 1.0≤x≤3.0 and 2.0≤y≤4.0.

A lithium-ion cell according to this aspect of the disclosure surprisingly exhibited a superior cycle-life and current density.

### Anode

The lithium-ion cell according to the disclosure comprises a silicon anode. The silicon anode comprises a silicon layer and a current collector layer.

### Current Collector

Preferably, the current collector material according to the disclosure each have a thickness of from 1 to 100 μm, preferably of from 5 or 10 to 50 μm, more preferably of from 10 to 15 μm or about 10 or 12 μm.

Advantageously, the current collector material according to the disclosure may comprise copper, tin, chromium, nickel, titanium, stainless steel, or silver, or alloys thereof, more preferably copper or nickel, or alloys thereof, most preferably copper.

The current collector material includes sheet-like materials produced by either cold rolling or electroplating, and can also comprise alloys of copper or titanium with elements such as magnesium, zinc, tin, phosphor and/or silver. It can be smooth, rough, or textured, with a tensile strength preferably ranging from 150 to 600 MPa, and might comprise a passivation layer deposited on the copper foil to protect the copper foil from oxidation in air. The sheet-like materials produced by cold rolling or electroplating can have certain defects such as rolling lines, potential strains, impurities, and native oxide, which can impact the quality of the active material layer. Thus, the current collector material may be subjected to surface treatment. For example, the roughness of the foil can be increased to varying degrees by attaching nodules of current collector material or other metals at the surface of the current collector material, by for example electroplating. Other surface treatment techniques known in the art include annealing, knurling, etching, liquefying, physical polishing and electro-polishing, and are used to improve the morphology of the current collector material prior to deposition of active material.

Preferably, the current collector material according to the disclosure comprises a metal, metal alloy and/or metal salts and/or oxide. The metal, metal alloy and/or metal salts and/or oxide according to the disclosure are advantageously selected from aluminium, copper, nickel, tin, tin, indium and zinc, preferably nickel, ZnO or SnO₂, most preferably ZnO; preferably, wherein the current collector comprises a copper or nickel core layer, more

Preferably a core layer doped with oxides or fluorides of zinc, aluminium, tin or indium. Preferably, the metal, metal alloy and/or metal salts and/or oxide or the core layer are in a layer at a thickness of from 0.1 to 5 nm, more preferably of from 1 to 2 nm. Preferably, a current collector according to the disclosure comprising copper or nickel comprises nickel, ZnO or SnO₂.

### Optional Interstitial Adhesion Layer

In the pending international patent application WO2021029769 of current applicant, it is disclosed that an adhesion layer comprising a metal, metal alloy and/or metal salts and/or oxide attached to the current collector material, may advantageously increase the adhesion of the silicon material to the current collector material of the composite electrode. Such an interstitial adhesion layer is not essential. According to the present disclosure, the current collector material comprising a metal, metal alloy and/or metal salts and/or oxide adhesion layer preferably comprises an adhesion layer. This adhesion layer increases the adhesion between silicon material and the current collector material as different complexes of silicon are being formed on the interphase between the current collector material and the silicon. Such an adhesion layer preferably comprises nickel, zinc or tin, such as ZnO or SnO₂. The adhesion layer can be formed by coating or depositing the metal, metal alloy and/or metal salts and/or oxide on the current collector material. Preferably, the adhesion layer is in a layer at a thickness of from 0.1 to 5 nm, more preferably of from 1 to 2 nm.

### Silicon Layer

The silicon layer of the silicon anode comprises a plurality of columnar structures on the current collector. The silicon layer is present on the current collector layer.

The silicon layer according to the disclosure is attached to the current collector layer, either directly, or by attachment to an interstitial adhesion layer, as a layer comprising a plurality of adjacent columns with a diameter of from 0.5 to 100 μm.

Preferably, the columns have a diameter of from 1 to 75 μm, more preferably of from 2 to 50 μm, even more preferably of from 3 to 25 μm, yet more preferably of from 4 to 20 μm, even more preferably of from 5 to 15 μm, yet more preferably of from 6 to 12 μm, most preferably of from 8 to 10 μm.

Preferably, the columns have a mean average diameter of from 1 to 75 μm, more preferably of from 2 to 50 μm, even more preferably of from 3 to 25 μm, yet more preferably of from 4 to 20 μm, even more preferably of from 5 to 15 μm, yet more preferably of from 6 to 12 μm, most preferably of from 8 to 10 μm.

Preferably, the columns predominantly extend in a perpendicular direction from the current collector layer surface. Herein, the adjacent columns may advantageously be separated by column boundaries extending essentially in the perpendicular direction. This may be determined by cross-sectional electron microscopy.

Preferably, according to the disclosure the at least one silicon layer has a thickness of from 0.1 to 1,000 μm, preferably of from 0.5 to 500 μm, more preferably of from 1 to 100 or 200 μm, even more preferably of from 1 to 30 or 50 μm, yet more preferably of from 3 μm to 20 μm, yet more preferably of from 5 to 15 μm and most preferably of from 6 to 10 μm. Alternatively, according to the disclosure, the at least one silicon layer preferably has a mass loading of from 0.1 to 4.0 mg/cm², more preferably of from 0.5 or 0.8 to 2.0 to 2.5 mg/cm², or of from 2.5 to 3.5 or 4.0 mg/cm², most preferably of from 1.0 to 2.0 mg/cm². The mass loading pertains to mass loading of one silicon layer that is present on one side of a current collector layer.

Advantageously, the at least one silicon layer according to the disclosure has a porosity of from 0% to 50%, more preferably 1%, 2%, 5% or 10% to 50%.

Preferably, the silicon layer according to the disclosure has a porosity of from 0% to 80%, preferably 5-60%, even more preferably, 10-40%, as determined by the BJH method of ISO 15901-2: 2006

Preferably, the average pore size of the silicon layer is in the range of from 0.5 to 40 nm, preferably of from 1 to 20 nm.

Porosity and (average) pore size according to the disclosure are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Briefly, a N₂ adsorption-isotherm is measured at about −196° C. (liquid nitrogen temperature). According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then dried and placed in the measuring apparatus. Next, the sample is brought under vacuum and cooled using liquid nitrogen. The sample is held at liquid nitrogen temperature during recording of the isotherm.

The silicon layer according to the disclosure has preferably an amorphous structure in which nano-crystalline regions exist. More preferably, the silicon layer or the columns comprise up to 30% of nano-crystalline silicon. According to an embodiment, the silicon layer advantageously comprises n-type or p-type dopants to obtain a silicon layer of respectively n-type conductivity or p-type conductivity.

Advantageously, the silicon columns may further comprise a silicon alloy, wherein the silicon alloy is preferably selected from the group comprising Si—C and/or Si—N. Preferably, the composite material according to the disclosure comprises carbon or an alloy comprising carbon or silicon. The silicon alloy may be either an addition or an alternative to the amorphous silicon. Thus, according to an aspect of the disclosure, the material of the columns comprises at least one material selected from amorphous silicon and amorphous silicon alloy.

According to a further aspect, the material of the columns comprises amorphous silicon and nano-crystalline silicon alloy. In some embodiments, the silicon alloy may be present in the electrode layer as a nano-crystalline phase. Also, the anode layer may comprise a mixture of an amorphous material and nano-crystalline phase. For example, a mixture of amorphous silicon and nanocrystalline silicon, or a mixture of amorphous silicon with nano-crystalline silicon alloy, or a mixture of silicon and silicon-based alloy predominantly in an amorphous state comprising a fraction (up to about 30%) of the mixture in a nano-crystalline state. According to the present disclosure, the amorphous silicon columns are preferably extending in a perpendicular direction from the anode surface, i.e. the interphase between the anode layer and the electrolyte layer, in which the plurality of silicon columns are arranged adjacent to each other while separated by interphases extending perpendicularly to the anode surface.

The silicon layer according to the disclosure may advantageously comprise silicon oxide. The silicon layer according to the disclosure may be positioned on the current collector layer in a variety of configurations. The silicon may be on nanowire templates that are attached to a substrate such as the current collector layer or the adhesion layer. The term “nanowire” herein is understood to mean a branched or non-branched wire-like structure with at least one dimension with a length of up to about 1 μm. The nanowire is an electrically conductive material comprising for example carbon, a metal or a metal silicide such as nickel silicide, copper silicide, silver silicide, chromium silicide, cobalt silicide, aluminium silicide, zinc silicide, titanium silicide or iron silicide, preferably comprising at least one nickel silicide phase comprising Ni₂Si, NiSi or NiSi₂. The nanowire may be the same material as the current collector such as nickel, copper or titanium. Alternatively, the nanowire may be a separate material and layer from the current collector material such as a copper current collector coated with a nickel layer. One or more layers of active material such as silicon may be deposited on nanowires via for example PVD, CVD or PECVD. The silicon layer may comprise carbon, copper, a sulfide, a metal oxide, a fluorine containing compound, a polymer or a lithium phosphorous oxynitride. The silicon layer may be coated with a layer comprising carbon, copper, a sulfide, a metal oxide, a fluorine containing compound, a polymer or a lithium phosphorous oxynitride, preferably a carbon layer with a thickness of from 1 nm to 5 μm, preferably of from 10 nm to 1 μm.

### Optional Electrode Tab

In a preferable embodiment, the lithium-ion cell according to the disclosure additionally comprises an electrode tab. More preferably, lithium-ion cell according to the disclosure additionally comprises an electrode tab comprising nickel or copper or an alloy comprising nickel, copper, tin, silicon, copper and nickel, copper and tin or copper and silicon. Most preferably, the tab material comprises nickel.

The tab is preferably a sheet-like material comprising a metal with a thickness of from 1 μm to 1 mm, more preferably of from 10 to 500 μm, of from 20 to 200 μm, from 50 to 150 μm or about 100 μm.

### Cathode

The cell according to the disclosure comprises a cathode. Cathodes suitable to use in the present disclosure are known to the skilled person and are commercially available.

Preferably cathodes, or positive electrodes, or the materials they are essentially composed of are selected from:
a carbon/sulphur composite, or an air electrode, in particular carbon-based electrodes comprising graphitic carbon and, optionally, a metal catalyst such as Ir, Ru, Pt, Ag, or Ag/Pd); carbon monofluoride; CuO (copper (II) oxide); Cr₂O₅; Cr₃O₈; Iron disulfide; Li₂M²SiO₄ (M²=Mn, Fe, or Co), Li₂M²SO₄ (M²=Mn, Fe, or Co), LiM₂SO₄ₘF (M₂=Fe, Mn, or Co), Li₂₋ₓ(Fe_{1-y}Mn_{y})P₂O₇ (0≤x≤1; 0≤y≤1), Li₃V₂₋ₓM1ₓ (PO₄)₃ (M1=Cr, Co, Fe, Mg, Y, Ti, Nb, or Ce; 0≤x≤1); Li₄₋ₓMₓTi₅O₁₂ (M=Mg, Al, Ba, Sr, or Ta; 0≤x≤1); LiCoO₂; LiFePO₄ (LFP); LiMC1ₓ MC²₁₋ₓO₂ ((MC1 and MC2 independently are Fe, Mn, Ni, Co, Cr, Ti, Mg, or Al; 0≤x≤1); LiMC1ₓMC2₁₋ₓPO₄ (MC1 or MC2=Fe, Mn, Ni, Co, Cr, or Ti; 0≤x≤1); LiMC1ₓMC2_{y}MC3_{1-x-y}O₂(MC1, MC2, and MC3 independently are Fe, Mn, Ni, Co, Cr, Ti, Mg, or Al; 0≤x≤1; 0≤y≤1, 0≤x+y≤1); LiMn₂O₄ (LMO); LiMn_{2-y}X_{y}O₄ (X=Cr, Al, or Fe, 0≤y≤1); LiNi_{0.5}Mn_{1.5}O₄ spinel; LiNi_{0.5-y}X_{y}Mn_{1.5}O₄ (X=Fe, Cr, Zn, Al, Mg, Ga, V, or Cu; 0≤y<0.5); LiNi_{0.8}Co_{0.15}Al_{0.05}O₂ (NCA); LiNiₓMn_{y}Co_{Z}O₂ (NMC, x+y+z=1), Li-rich Li_{1+w}NiₓMn_{y}Co_{Z}O₂ (x+y+z+w=1, 0≤w≤0.25); LiV₃O ₈; LiVPO₄F; MnO₂; Thionyl chloride; V₂O₅; V₆O₁; xLi₂MnO₃·(1−x)LiM¹_{y}M²M³_{1-y-z}O₂, wherein M¹, M², and M³ independently are Mn, Ni, Co, Cr, Fe, or mixture thereof; and wherein x=0.3-0.5; y≤0.5; z≤0.5;

In a preferred embodiment, the cathode is a lithium conversion compound, such as Li₂O₂, Li₂O, Li₂S, or LiF. More preferably, the cathode comprises LiNi_{X}Mn_{Y}Co_{Z}O₂ where x≥0.6 (NMC) or LiNiₓMg_{y}Ti_{1-x-y}O₂ where 0.9≤x<1 (NMT; e.g., LiNi_{0.96}Mg_{0.02}Ti_{0.02}O₂). In a particularly preferred embodiment, the cathode is selected from one or more high voltage cathodes, by which is meant a cathode that can operate at from 4.3 to 4.6 V.

### Separator

Cells according to the present disclosure comprise a separator. A separator is present to prevent short circuits forming between the cathode and anode, while still allowing ions to flow between both electrodes.

The separator may be suitably selected: (i) glass fiber; (ii) a porous polymer film with or without a ceramic coating, such as a polyethylene- or polypropylene-based material, or (iii) a composite (e.g., a porous film of inorganic particles and a binder). One exemplary polymeric separator is a Celgard© K1640 polyethylene (PE) membrane. Another exemplary polymeric separator is a Celgard© 2500 polypropylene membrane. Another exemplary polymeric separator is a Celgard© 3501 surfactant-coated polypropylene membrane.

Another set of exemplary porous polymer film with a ceramic coating are the PE and PP separators obtainable from Gelon. One example of such a separator is the Gelon 16 μm thick PE Battery separator, which comprises a 12 μm thick polyethylene polymer film, coated on both sides with a 2 μm thick ceramic alumina layer to afford a separator with a porosity of 38%.

The separator may optionally be infused with an electrolyte.

### Electrolyte

Cells according to the present disclosure comprise an electrolyte. This electrolyte comprises:
i. of from 9 to 29 wt. %, with respect to the electrolyte, of a lithium salt;
ii. a non-aqueous solvent;
iii. a diluent;
   the electrolyte having a lithium salt-solvent-diluent molar ratio of 1:x:y, where 1.0≤x≤3.0 and 2.0≤y≤4.0.

### Lithium Salt

The electrolyte comprises 9 to 29 wt. %, with respect to the electrolyte, of a lithium salt.

The lithium salt, or combination of lithium salts, participates in the cell's charge and discharge processes.

Preferably, the lithium salt comprises: LiAsF₆; Li₂SO₄; LiBF₄; LiBr; LiCF₃SO₃; LiCl; LiClO₄, LiI; LiNO₂; LiNO₃; LiSCN; lithium 2-trifluoromethyl-4,5-dicyanoimidazole (CAS: 761441-54-7); lithium (fluorosulfonyl)(trifluoromethylsulfonyl) imide (LiFTFSI); lithium bis(fluorosulfonyl)imide (LiFSI); lithium bis(oxalato)borate (LiBOB); lithium bis(pentafluoroethanesulfonyl) imide (LiBETI); lithium bis(trifluoromethanesulfonyl)imide (LiTFSI); lithium difluoro(oxalato)borate (LiDFOB CAS: 409071-16-5); lithium trifluoromethanesulfonate (LiTf); LiPF₆; or any combination thereof.

More preferably, the electrolyte comprises 9 to 29 wt. %, with respect to the electrolyte, of a lithium salt selected from: LiAsF₆; Li₂SO₄; LiBF₄; LiBr; LiCF₃SO₃; LiCl; LiClO₄, LiI; LiNO₂; LiNO₃; LiSCN; lithium 2-trifluoromethyl-4,5-dicyanoimidazole (CAS: 761441-54-7); lithium (fluorosulfonyl)(trifluoromethylsulfonyl) imide (LiFTFSI); lithium bis(fluorosulfonyl)imide (LiFSI); lithium bis(oxalato)borate (LiBOB); lithium bis(pentafluoroethanesulfonyl) imide (LiBETI); lithium bis(trifluoromethanesulfonyl)imide (LiTFSI); lithium difluoro(oxalato)borate (LiDFOB CAS: 409071-16-5); lithium trifluoromethanesulfonate (LiTf); LiPF₆; or any combination thereof.

Most preferably, the lithium salt comprises essentially of lithium bis(fluorosulfonyl)imide.

### Non-Aqueous Solvent

The electrolyte comprises a non-aqueous solvent. The non-aqueous solvent is advantageously selected such that the lithium salt has a solubility in the selected solvent of at least 3 M (mole/dm³) at 25° C. and 1 atm.

Preferably, the non-aqueous solvent is selected such that the lithium salt has a solubility in the selected solvent of at least 4 M at 25° C. and 1 atm, more preferably of at least 5 M at 25° C. and 1 atm.

Without being bound by theory, it is believed that the solvent molecules in the electrolyte according to the present disclosure are statistically most likely to be closely associated with the lithium-ion salt(s), forming aggregates. It is further believed that these solvent-lithium salt aggregates are suspended in a continuous phase of the diluent.

Preferably, the non-aqueous solvent is selected from a nonaqueous solvent comprising at least one of the following components (i) an ester, (ii) a sulfur-containing solvent, (iii) a phosphorus-containing solvent, (iv) an ether, (v) a nitrile, or (vi) any combination thereof.

### Ester Solvent

Preferably, the ester is be selected from: diethyl carbonate (DEC); difluoroethylene carbonate (DFEC); dimethyl carbonate (DMC); ethyl methyl carbonate (EMC); ethylene carbonate (EC); methyl 2,2,2,-trifluoroethyl carbonate (MFEC); propylene carbonate (PC); trifluoroethylene carbonate (TFEC); trifluoropropylene carbonate (TFPC); 2,2,2,-trifluorethyl trifluoroacetate; 2,2,2-trifluoroethyl acetate; alkyl carboxylic acid esters, such as ethyl acetate; ethyl propionate; ethyl trifluoroacetate; methyl butyrate, or any combination thereof.

More preferably, the ester is be selected from: 2,2,2,-trifluorethyl trifluoroacetate; 2,2,2-trifluoroethyl acetate; ethyl acetate; ethyl propionate; ethyl trifluoroacetate; methyl butyrate, and/or any combination thereof.

### Sulphur-Containing Solvent

Preferably, the sulphur-containing solvent is selected from sulfone solvents, sulfoxide solvents or any combination thereof. More preferably, the sulphur-containing solvent is selected from: dimethyl sulfone; dimethyl sulfone; ethyl methyl sulfone (EMS); ethyl vinyl sulfone (EVS); tetramethylene sulfone (TMS, sulfolane); dimethyl sulfoxide; ethyl methyl sulfoxide; ethyl methyl sulfone (EMS); ethyl vinyl sulfone (EVS); tetramethylene sulfone (TMS, sulfolane); dimethyl sulfoxide; ethyl methyl sulfoxide; or any combination thereof.

### Phosphorus-Containing Solvents

Preferably, the phosphorus-containing solvent is selected from organophosphorus compounds (such as organic phosphate, phosphites, phosphonates, phosphoramides), phosphazenes (organic or inorganic) or any combination thereof. These phosphorus-containing solvents are generally flame retardant.

More preferably, the phosphorus-containing solvent is selected from: bis(2,2,2-trifluoroethyl) methyl phosphate; tributyl phosphate; triethylphosphate (TEPa); trimethyl phosphate (TMPa); triphenyl phosphate; tris (2,2,2-trifluoroethyl) phosphate; trimethyl phosphite; triphenyl phosphite; tris(2,2,2-trifluoroethyl) phosphite; dimethyl methylphosphonate; diethyl ethylphosphonate; diethyl phenylphosphonate; bis(2,2,2-trifluorethyl) methylphosphonate; hexamethylphosphoramide; hexamethoxyphosphazene (CAS: 957-13-1); hexamethoxycyclotriphosphazene (CAS: 6607-30-3); hexafluorophosphazene (CAS: 15599-91-4); or any combination thereof.

### Ether Solvent

Preferably, the ether solvent is selected from: 1,2-dimethoxyethane (DME); diethylene glycol dimethyl ether (diglyme, DEGDME); triethylene glycol dimethyl ether (triglyme); tetraethylene glycol dimethyl ether (tetraglyme); 1,3-dioxolane (DOL); allyl ether; or any combination thereof.

### Nitrile Solvents

Preferably, the nitrile solvent is selected from: acetonitrile; propionitrile; succinonitrile; adiponitrile (CAS: 111-69-3); or any combination thereof. The electrolyte preferably comprises a non-aqueous solvent selected from: dimethyl carbonate (DMC); ethyl methyl carbonate (EMC); diethyl carbonate (DEC); ethylene carbonate (EC); propylene carbonate (PC); difluoroethylene carbonate (DFEC); trifluoroethylene carbonate (TFEC); trifluoropropylene carbonate (TFPC); methyl 2,2,2-trifluoroethyl carbonate (MFEC); ethyl acetate; ethyl propionate; methyl butyrate; ethyl trifluoroacetate; 2,2,2-trifluoroethyl acetate; 2,2,2-trifluoroethyl trifluoroacetate; dimethyl sulfone (DMS); ethyl methyl sulfone (EMS); ethyl vinyl sulfone (EVS); tetramethylene sulfone (TMS); dimethyl sulfoxide; ethyl methyl sulfoxide; trimethyl phosphate (TMPa); triethyl phosphate (TEPa); tributyl phosphate; triphenyl phosphate; tris(2,2,2-trifluoroethyl) phosphate; bis(2,2,2-trifluoroethyl) methyl phosphate; trimethyl phosphite; triphenyl phosphite; tris(2,2,2-trifluoroethyl) phosphite; dimethyl methylphosphonate; diethyl ethylphosphonate; diethyl phenylphosphonate; bis(2,2,2-trifluoroethyl) methylphosphonate; hexamethylphosphoramide; hexamethoxyphosphazene; hexamethoxycyclotriphosphazene; hexafluorophosphazene; 1,2-dimethoxyethane (DME); diethylene glycol dimethyl ether (diglyme, DEGDME); triethylene glycol dimethyl ether (triglyme); tetraethylene glycol dimethyl ether (tetraglyme); 1,3-dioxolane (DOL); allyl ether; acetonitrile; propionitrile; succinonitrile; adiponitrile (CAS: 111-69-3); or any combination thereof.

Even more preferably, the non-aqueous solvent is selected from: ethyl acetate; ethyl propionate; methyl butyrate; ethyl trifluoroacetate; 2,2,2-trifluoroethyl acetate; 2,2,2-trifluoroethyl trifluoroacetate; dimethyl sulfone (DMS); ethyl methyl sulfone (EMS); ethyl vinyl sulfone (EVS); tetramethylene sulfone (TMS); dimethyl sulfoxide; ethyl methyl sulfoxide; trimethyl phosphate (TMPa); triethyl phosphate (TEPa); tributyl phosphate; triphenyl phosphate; tris(2,2,2-trifluoroethyl) phosphate; bis(2,2,2-trifluoroethyl) methyl phosphate; trimethyl phosphite, triphenyl phosphite; tris(2,2,2-trifluoroethyl) phosphite; dimethyl methylphosphonate; diethyl ethylphosphonate; diethyl phenylphosphonate; bis(2,2,2-trifluoroethyl) methylphosphonate; hexamethylphosphoramide; hexamethoxyphosphazene (cyclo-tris(dimethoxyphosphonitrile); hexamethoxycyclotriphosphazene); hexafluorophosphazene (hexafluorocyclotriphosphazene); 1,2-dimethoxyethane (DME); diethylene glycol dimethyl ether (DEGDME, or diglyme); triethylene glycol dimethyl ether (triglyme); tetraethylene glycol dimethyl ether (tetraglyme); 1,3-dioxolane (DOL); allyl ether; acetonitrile; propionitrile; or any combination thereof. Most preferably, the solvent is 1,2-dimethoxyethane (DME). Diluent The electrolyte comprises a diluent. The diluent is advantageously selected such that the lithium salt has a solubility in the selected solvent of less than 0.3 M (mole/dm 3) at 25° C. and 1 atm. Preferably, the diluent is selected such that the lithium salt has a solubility in the selected diluent of less than 0.2 M, more preferably of less than 0.1 M, even more preferably of less than 0.05 M, most preferably of less than 0.01 M at 25° C. and 1 atm. Preferably, the diluent is selected from a diluent comprising one or more of: a fluoroalkyl ether; a fluorinated orthoformate, a fluorinated carbonate, a fluorinated borate; or a combination thereof. More preferably, the diluent is selected from: a fluoroalkyl ether; a fluorinated orthoformate, a fluorinated carbonate, a fluorinated borate; or a combination thereof. Even more preferably, the diluent is selected from: 1,1,2,2-tetrafluoroethyl-2,2,2,3-tetrafuoropropyl ether (TTE); 1,1,2,2-tetrafluoroethyl-2,2,2-trifluoroethylether (TFTFE); 1,2,2,2-tetrafluoroethyl trifluoromethyl ether; 1H,1H,5H-octafluoropentyl 1,1,2,2-tetrafluoroethyl ether (OTE); bis(2,2,2-trifluoroethyl) carbonate; bis(2,2,2-trifluoroethyl) ether(BTFE); bis(2,2,2-trifluoroethyl) methyl orthoformate (BTFEMO); ethoxynonafluorobutane (EOFB); heptafluoroisopropyl methyl ether; methoxynonafluorobutane (MOFB); tris(2,2,2-trifluoroethyl) borate; tris(2,2,2-trifluoroethyl) orthoformate (TFEO); tris(2,2,3,3,3-pentafluoropropyl) orthoformate (TPFPO); tris(2,2,3,3-tetrafuoropropyl) orthoformate (TTPO); tris(2,2-difluoroethyl) orthoformate (TDFEO); tris(hexafluoroisopropyl) orthoformate (THFiPO); or any combination thereof. Yet more preferably, the diluent is selected from: 1,1,2,2-tetrafluoroethyl-2,2,2,3-tetrafuoropropyl ether (TTE); 1,1,2,2-tetrafluoroethyl-2,2,2-trifluoroethylether (TFTFE); 1H,1H,5H-octafluoropentyl 1,1,2,2-tetrafluoroethyl ether (OTE); bis(2,2,2-trifluoroethyl) ether(BTFE); bis(2,2,2-trifluoroethyl) methyl orthoformate (BTFEMO); ethoxynonafluorobutane (EOFB); methoxynonafluorobutane (MOFB); tris(2,2,2-trifluoroethyl) orthoformate (TFEO); tris(2,2,3,3,3-pentafluoropropyl) orthoformate (TPFPO); tris(2,2,3,3-tetrafuoropropyl) orthoformate (TTPO); tris(2,2-difluoroethyl) orthoformate (TDFEO); tris(hexafluoroisopropyl) orthoformate (THFiPO); or any combination thereof.

Most preferably, the diluent is 1,1,2,2-tetrafluoroethyl-2,2,2,3-tetrafuoropropyl ether (TTE).

### Electrolyte Composition Ratios

The electrolyte according the present disclosure has a lithium salt-solvent-diluent molar ratio of 1:x:y, where 1.0≤x≤3.0 and 2.0≤y≤4.0.

Preferably, the electrolyte has a lithium salt-solvent-diluent molar ratio of 1:x:y, where 1.1≤x≤2.5 and 2.2≤y≤3.8, more preferably 1.2≤x≤2.0 and 2.4≤y≤3.6, even more preferably 1.2≤x≤1.8 and 2.6≤y≤3.4 and most preferably x=1.2 and y=3.0.

More preferably, the electrolyte is one in which the lithium salt is lithium bis(fluorosulfonyl)imide and the electrolyte has a lithium salt-solvent-diluent molar ratio of 1:x:y, where 1.1≤x≤21.5 and 2.2≤y≤3.8, more preferably 1.2≤x≤2.01.4 and 2.4≤y≤3.6, even more preferably 1.2≤x≤1.84 and 2.6≤y≤3.4 and most preferably x=1.2 and y=3.0.

Even more preferably, the electrolyte is one in which the lithium salt is lithium bis(fluorosulfonyl)imide and the non-aqueous solvent is 1,2-dimethoxyethane, wherein the electrolyte has a lithium salt-solvent-diluent molar ratio of 1:x:y, where 1.1≤x≤21.5 and 2.2≤y≤3.8, more preferably 1.2≤x≤2.01.4 and 2.4≤y≤3.6, even more preferably 1.2≤x≤1.84 and 2.6≤y≤3.4 and most preferably x=1.2 and y=3.0.

Yet more preferably,, the electrolyte is one in which the diluent is 1,1,2,2-tetrafluoroethyl 2,2,3,3-tetrafluoropropyl ether, wherein the electrolyte has a lithium salt-solvent-diluent molar ratio of 1:x:y, where 1.1≤x≤21.5 and 2.2≤y≤3.8, more preferably 1.2≤x≤2.01.4 and 2.4≤y≤3.6, even more preferably 1.2≤x≤1.84 and 2.6≤y≤3.4 and most preferably x=1.2 and y=3.0.

Most preferably, the electrolyte is one in which the lithium salt is lithium bis(fluorosulfonyl)imide; the non-aqueous solvent is 1,2-dimethoxyethane; and the diluent is 1,1,2,2-tetrafluoroethyl 2,2,3,3- tetrafluoropropyl ether, wherein the electrolyte has a lithium salt-solvent-diluent molar ratio of 1:x:y, where 1.1≤x≤21.5 and 2.2≤y≤3.8, more preferably 1.2≤x≤2.01.4 and 2.4≤y≤3.6, even more preferably 1.2≤x≤1.84 and 2.6≤y≤3.4 and most preferably x=1.2 and y=3.0.

### Additives

Preferably, the electrolyte according to the disclosure additionally comprises an additive. The additive has a different composition than: (i) the lithium salt; (ii) the solvent; and (iii) the diluent. Optionally, the additive is a flame retardant.

Preferably, the additive comprises: 4-Fluoro-1,3-dioxolan-2-one (FEC, CAS: 114435-02-8), 1,3-Dioxol-2-one (VC, vinylene carbonate, CAS: 872-36-6), 1,4-Dicyanobutane, (adiponitrile, CAS: 111-69-3), Lithium difluorophosphate (LiDFP), 4,5-dimethylene-1,3-dioxolan-2-one; 1,3,2-dioxathiolane-2-oxide (CAS: 3741-38-6); 1,3,2-dioxathiolane-2,2-dioxide(CAS: 1072-53-3); 1,3,2-dioxathiane-2,2-dioxide (DTD, CAS: 1072-53-3); 3-methyl-1,4,2-dixoazol-5-one (CAS: 854849-14-2); Tris(2,2,2-trifluoroehtyl)phosphite (TTFEPi, CAS: 370-69-4); 1,3,2-Dioxathiane 2-oxide (CAS: 4176-55-0); 1-methylsulfonylethene (CAS: 3680-02-2); 1-ethenylsulfonylethene (CAS: 77-77-0); or any combination thereof.

### Method of Making an Electrolyte

In another aspect, the disclosure relates to a method of making an electrolyte according to the aspect above, comprising the following steps: Dissolving 9 to 29 wt. % lithium bis(fluorosulfonyl)imide, with respect to the electrolyte, in the non-aqueous solvent 1,2-dimethoxyethane; Adding the 1,1,2,2-tetrafluoroethyl 2,2,3,3-tetrafluoropropyl ether diluent to the solution comprising the lithium salt; Mixing the diluent/solution mixture until a homogeneous suspension is obtained.

Without being bound by theory, it is believed that the resultant electrolyte possess advantageous electrolyte properties.

### Manufacture of Lithium-Ion Cells

Another aspect of the disclosure relates to a method of manufacturing lithium-ion cells according to any previous aspect or specific embodiment, comprising the steps of:
Providing a silicon anode, the silicon anode comprising:
   (i) a silicon layer; and
   (ii) a current collector layer,
      the silicon layer comprising a plurality of columnar structures on a current collector;
placing a separator onto the silicon anode;
placing a cathode onto the separator to form a stack;
connecting the cathode and anode to electrode tabs;
insert stack of the anode, separator and cathode into a cell housing;
adding an electrolyte, the electrolyte comprising:
   (i) 9 to 29 wt. %, with respect to the electrolyte, of a lithium salt;
   (ii) a non-aqueous solvent;
   (iii) a diluent;
      the electrolyte having a lithium salt-solvent-diluent molar ratio of 1:x:y, where 1.0≤x≤3.0 and 2.0≤y≤4.
sealing the cell housing so as to prevent the electrolyte being able to leave the cell housing.

In the context of the present aspect of the disclosure: (i) the silicon anode; (ii) the separator; (iii) the cathode; (iv) the electrolyte may be as described in any previous aspect or specific embodiment above

Preferably, cell housing is a pouch. More preferably, the cell housing is a laminated aluminium pouch.

Preferably, the step of sealing the cell housing is conducted in a dry atmosphere. More preferably, the step of sealing the cell housing is conducted under an inert atmosphere. By way of non-limiting example, such an inert atmosphere may be nitrogen gas or argon gas.

Another aspect of the disclosure relates to a method of manufacturing lithium-ion cells according to any previous aspect or specific embodiment, comprising the steps of:
providing a silicon anode, the silicon anode comprising:
   (i) a first silicon layer;
   (ii) a second silicon layer; and
   (iii) a current collector layer,
      the silicon layer comprising a plurality of columnar structures on a current collector;
placing a first separator onto the first silicon layer of the silicon anode;
placing a second separator onto the second silicon layer of the silicon anode;
placing a first cathode onto the first separator;
placing a second cathode onto the second separator to form a stack;
connecting the cathode and anode to electrode tabs;
insert stack of the anode, separator and cathode into a cell housing;
adding an electrolyte, the electrolyte comprising:
   (i) 9 to 29 wt. %, with respect to the electrolyte, of a lithium salt;
   (ii) a non-aqueous solvent;
   (iii)a diluent;
      the electrolyte having a lithium salt-solvent-diluent molar ratio of 1:x:y, where 1.0≤x≤3.0 and 2.0≤y≤4.
sealing the cell housing so as to prevent the electrolyte being able to leave the cell housing.

In the context of the present aspect of the disclosure: (i) the silicon anode; (ii) the separators; (iii) the cathodes; (iv) the electrolyte may be as described in any previous aspect or specific embodiment above.

Preferably, the cell housing is a pouch. More preferably, the cell housing is a laminated aluminium pouch.

Preferably, the step of sealing the cell housing is conducted in a dry atmosphere. More preferably, the step of sealing the cell housing is conducted under an inert atmosphere. By way of non-limiting example, such an inert atmosphere may be nitrogen gas or argon gas.

A lithium-ion cell according to this aspect of the disclosure surprisingly possess superior cycle-life and capacity.

### Method of Forming a Solid Electrolyte Interphase Layer in a Lithium-Ion Cell

Another aspect of the disclosure relates to a method of forming a solid electrolyte interphase layer in a lithium-ion cell according to any previous aspect or embodiment, comprising the following steps in the following order:
(i) providing of a lithium-ion cell according to any preceding claim;
(ii) charging to at least 4.0 V;
(iii) discharging to 3.0 V.
   Preferably, the method comprises the following steps in the following order:
(i) providing of a lithium-ion cell according to any preceding claim;
(ii) charging to at least 4.2 V;
(iii) discharging to 2.5 V.
   More preferably, the method comprises the following steps in the following order:
(i) providing a lithium-ion cell according to any previous aspect or embodiment;
(ii) charging to at least 4.2 V;
(iii) discharging to 2.5 V;
(iv) charging to at least 4.2 V.
   Even more preferably, the method comprises the following steps in the following order:
(i) providing a lithium-ion cell according to any previous aspect or embodiment;
(ii) charging to at least 4.2 V;
(iii) discharging to 2.5 V;
(iv) charging to at least 4.2 V;
(v) discharging to 2.5 V.
   Yet more preferably, the method comprises the following steps in the following order:
(i) providing a lithium-ion cell according to any previous aspect or embodiment;
(ii) charging to at least 4.2 V;
(iii) discharging to 2.5 V;
(iv) charging to at least 4.2 V;
(v) discharging to 2.5 V;
(vi) charging to at least 4.2 V.

Preferably the first charging step to at least 4.0 V, more preferably 4.2 V, comprises:
charging for between 1 and 24 hours at a rate of from 0.001 C to 0.1 C; and
optionally, increasing the charge rate to 0.1 C until reaching 4.2.

More preferably the first charge to at least 4.0 V, yet more preferably still 4.2 V, comprises:
charging for between 2 and 18 hours at a rate of from 0.002 C to 0.05 C; and
optionally, increasing the charge rate to 0.1 C until reaching 4.2 V.

More preferably the first charge to at least 4.0 V, even more preferably to 4.2 V, comprises:
charging for between 4 and 12 hours at a rate of from 0.005 C to 0.02 C; and optionally, increasing the charge rate to 0.1 C until reaching 4.2 V.
   Even more preferably the first charge to at least 4.2 V comprises:
charging for between 6 and 10 hours at a rate of from 0.01 C; and
   increasing the charge rate to 0.1 C until reaching 4.2 V.

Preferably, the first discharge to 3.0 V, more preferably 2.5 V, is at 0.02 to 0.2 C, more preferably at 0.05 to 0.15 C, even more preferably at 0.08 to 0.12 C and most preferably at 0.1 C.

Preferably, the second charge to at least 4.0 V, more preferably 4.2, V is at 0.05 C to 0.4 C, more preferably at 0.1 to 0.3 C, even more preferably at 0.15 to 0.25 C and most preferably at 0.2 C.

Preferably, the second discharge to 3.0 V, more preferably to 2.5 V, is at 0.05 C to 0.4 C, more preferably at 0.1 to 0.3 C, even more preferably at 0.15 to 0.25 C and most preferably at 0.2 C.

Preferably, the third charge to at least 4.0 V, more preferably 4.2 V, is at 0.05 C to 0.4 C, more preferably at 0.1 to 0.3 C, even more preferably at 0.15 to 0.25 C and most preferably at 0.2 C.

In a particularly preferred embodiment of this aspect of the disclosure relates to a method of forming a solid electrolyte interphase layer in a lithium-ion cell according to any previous aspect or embodiment, comprising the following steps in the following order:
(i) providing a lithium-ion cell according to any of claims 1-7;
(ii) charging at 0.01 C for 10 hours;
(iii) charging at 0.1 C for either (i) 9 hours or (ii) until reaching 4.2 V;
(iv) discharging at 0.1 C until reaching 2.5 V;
(v) charging at 0.2 C until reaching 4.2 V;
(vi) discharging at 0.2 C until reaching 2.5 V;
(vii) charging at 0.2 C for 90 minutes.

A lithium-ion cell according to this aspect of the disclosure surprisingly possess superior cycle-life and current density.

### Product-By-Process

Another aspect of the disclosure relates to a lithium-ion cell obtainable by a process as set out herein above. A lithium-ion cell according to this aspect of the disclosure surprisingly possessed a superior cycle-life and capacity.

### Lithium-Ion Cells Comprising a Silicon Anode Comprising Primary Voids and a Solid Electrolyte Interphase Layer

Another aspect of the disclosure relates to a lithium-ion cell comprising:
a silicon anode, the silicon anode comprising:
   i. a current collector layer;
   ii. a silicon layer on the current collector layer; and
   iii. a solid electrolyte interphase layer,
the silicon layer comprising:
   i. a plurality of columnar structures on a current collector;
   ii. primary voids having a width of from 1 to 10 μm; and
   iii. optionally, secondary voids having a width of from 10 to 150 nm;
a cathode;
a separator; and
an electrolyte comprising:
   i. a lithium salt;
   ii. a non-aqueous solvent; and
   iii. a diluent.

A lithium-ion cell according to this aspect of the disclosure surprisingly possess superior cycle-life and current density.

Current collector and plurality of columnar structures on a current collector are as set out herein above for the first and further aspects of the present disclosure.

### Primary Voids

The term “primary void” or “primary void structure” in the context of the present disclosure means an area in the silicon layer that does not contain a component of the composite electrode, such as the silicon layer or the SEI layer. The primary void is preferably filled with electrolyte. Without being bound by theory, it is believed that the primary voids provide a space allows the silicon to expand into (parallel to the surface of the current collector layer) during use of the composite electrode material, lowering the amount of cracking, ablation or delamination of the silicon layer. It is further believed that the electrolyte can be present in the primary void space during use of the lithium ion cell, increasing the surface area available to transfer lithium ions. Typically, such primary voids appear only after cycling and/or use of the lithium ion cells.

Preferably, the primary voids have a width of from 2 to 9 μm, more preferably of from 3 to 8 μm, even more preferably of from 4 to 6 μm and most preferably 5 μm. Preferably, the primary voids have an orientation this is substantially perpendicular to the surface plane of the current collector material. The orientation can be determined from a cross-sectional electron microscope image perpendicular to the surface plane of the current collector material. Determination of the dimensions of the primary void or primary void structure may be performed by analysis of cross-sectional or top down images of the layers of anode material with a SOC of 0% by electron microscopy, wherein the cross section is perpendicular to the surface plane of the current collector layer. The width of a primary void or primary void structure is preferably determined over a continuous area of the void space or structure by analysis of cross-sectional images of the layers or material.

Width in this context means parallel to the surface of the current collector at the half-height of the silicon layer.

The height of the silicon is the average height of the silicon columns measured perpendicular to the surface of the current collector layer.

### Secondary Voids

The term “secondary void” or “secondary void structure” in the context of the present disclosure means an area in the silicon layer that does not contain a component of the composite electrode, such as the silicon layer or the SEI layer, with a width of less than 10 nm. Without being bound by theory, it is believed that the secondary voids provide a space allows the silicon to expand into (parallel to the surface of the current collector layer) during use of the composite electrode material, lowering the amount of cracking, ablation or delamination of the silicon layer.

Preferably, the secondary voids have a width of from 20 to 140 nm, more preferably of from 30 to 130 nm, even more preferably of from 40 to 120 nm, even more preferably of from 50 to 110 nm, still more preferably of from 60 to 100 nm and most preferably of from 70 to 90 nm.

Preferably, the secondary voids have an orientation this is substantially perpendicular to the surface plane of the current collector material. The orientation can be determined from a cross-sectional electron microscope image perpendicular to the surface plane of the current collector material. Preferably, the secondary void structures surround the outer curved surface of each of the plurality of columnar structures. Preferably, a secondary void structure extends from the bottom to the top of a respective silicon layer and surrounds, preferably continuously surrounds, a columnar structure, thereby defining an individual columnar structure.

Determination of the dimensions of the secondary void or primary void structure may be performed by analysis of cross-sectional images of the layers of anode material with a SOC of 0% by electron microscopy, wherein the cross section is perpendicular to the surface plane of the current collector layer. The width of a primary void or primary void structure is preferably determined over a continuous area of the void space or structure by analysis of cross-sectional images of the layers or material.

Width in this context means parallel to the surface of the current collector at the half-height of the silicon layer.

The height of the silicon is the average height of the silicon columns measured perpendicular to the surface of the current collector layer.

### Solid Electrolyte Interphase Layer

This may be any solid electrolyte interphase layer formed by charging and discharging the anode in the presence of a lithium salt containing electrolyte.

Preferably, the solid electrolyte interphase layer formed by charging and discharging the anode in the presence of an electrolyte according to any embodiment of the first aspect of the present disclosure.

### Batteries

In yet a further aspect, the present disclosure relates to a battery comprising at least one lithium-ion cell according to any previous embodiment of any previous aspect. An advantage of such a battery is that the mass of such a battery can be lower than those of the state of the art, whilst still possessing the same nominal voltage and capacity. In the context of the present disclosure a battery may contain one or more lithium-ion cells.

### Battery Shapes

Examples of such batteries are cylindrical, prismatic, pouch and coin batteries. Several configurations of lithium-ion cells can also be combined. For example, a coin cell can have an internal cylindrical configuration (as disclosed in international patent application WO2015188959A1) or a pouch cell can have an internal prismatic configuration.

Generally, lithium-ion secondary batteries are manufactured as follows. Firstly, positive and negative electrodes are provided. Subsequently, a plurality of positive electrode plates and a plurality of negative electrode plates are stacked in the state in which the separators are interposed respectively between the positive electrode plates and the negative electrode plates in order to manufacture a battery cell having a predetermined shape. Subsequently, the battery cell is placed in a battery case, and the electrolyte is provided to the battery case. The battery case is then usually sealed, resulting in a battery, such as a battery pack.

Electrode leads are connected to a general electrode assembly. Each of the electrode leads is configured to have a structure in which one end of the electrode lead is connected to the electrode assembly, the other end of the electrode lead is exposed outward from the battery case, and the battery case, in which the electrode assembly is placed, is sealed by an adhesive layer, such as a sealant layer, at the portion of the battery case from which the electrode lead extends outward from the battery case.

In addition, the electrode assembly is provided with electrode tabs. Each current collector plate of the electrode assembly includes a coated part, on which an electrode active material is coated, and an end part (hereinafter, referred to as a “non-coated part”), on which the electrode active material may be uncoated. Each of the electrode tabs may be formed by connecting the uncoated part, or preferably by connecting a separate conductive tab connected to the electrodes, even more preferably by ultrasonic welding. These electrode tabs may protrude in one direction such that the electrode tabs are formed at the electrode assembly so as to be arranged side by side. Alternatively, the electrode tabs may protrude in opposite directions. Each electrode tab conveniently then serves as a path along which electrons move between the inside and the outside of the battery. Also, each of the electrode leads is preferably connected to a corresponding electrode tab by spot welding.

The electrode leads may extend in the same direction or in opposite direction depending on the position at which positive electrode tabs and negative electrode tabs are formed. A positive electrode lead and a negative electrode lead may be made of different materials. Finally, the electrode leads are electrically connected to external terminals via terminal parts thereof.

A pouch-shaped sheathing member contains the electrode assembly in a sealed state such that a portion of each of the electrode leads, e.g., the terminal part of each of the electrode leads, is exposed from the pouch-shaped sheathing member. As previously described, the adhesive layer, such as a sealant layer, is interposed between each of the electrode leads and the pouch-shaped sheathing member. The pouch-shaped sheathing member is provided at the edge thereof with a sealed region. A horizontal slit of each of the electrode leads is spaced apart from the sealed region toward a joint. That is, in the case in which each of the electrode leads is formed so as to have an inverted T shape, the leg part of the T shape protrudes outward from the pouch-shaped sheathing member whereas a portion of the head part of the T shape is located in the sealed region.

### Prismatic Shape Batteries

In a preferable embodiment, the battery is an approximately rectangular shape with a height of 48.5 mm, a length of 26.5 mm and a width of 17.5 mm. Preferably, the battery has a nominal voltage of 9 volts. Preferably, the battery is rechargeable.

In a further embodiment, the disclosure relates to a rectangular battery comprising a cell according to any previous embodiment of any previous aspect. Preferably, the rectangular batter is selected from: a 4.5-volt lantern battery; a 6-volt (spring or screw fitting) lantern battery; a 7.5-volt lantern battery; a 12-volt lantern battery; or a 9-volt battery.

### Cylindrical-Shape Batteries

Cylindrical-shape lithium-ion secondary batteries typically include a spirally wound electrode assembly which includes a cathode and an anode spirally wound with a separator in between, and a pair of insulating plates in a substantially hollow cylindrical-shaped battery can. In a preferable embodiment, the battery is a cylindrical battery with a 17 mm diameter and a 34.5 mm height. Preferably, the battery has a nominal voltage of 3.6 volts. More preferably, the battery has a nominal voltage of 3.6 volts and a capacity of 700 mAh. Preferably, the battery is rechargeable.

In a preferable embodiment, the battery has a cylindrical shape with a 15.6 mm diameter and a length of 27 mm. Preferably, the battery has a nominal voltage of 3.6 volts. More preferably, the battery has a nominal voltage of 3.6 volts and a capacity of 600 or 800 mAh. Preferably, the battery is rechargeable.

In a preferable embodiment, the battery is a cylindrical battery with a 17 mm diameter and a 34.5 mm height. Preferably, the battery has a nominal voltage of 3.6 volts. More preferably, the battery has a nominal voltage of 3.6 volts and capacity of 700 mAh.

### Double-Cylinder-Shaped Batteries

In a preferable embodiment, the battery has a double cylinder shape, with a height of 52.20 mm, a length of 28.05 mm and a width of 14.15 mm. More preferably, the battery has a nominal voltage of 3.6 volts and capacity of 1,300 mAh.

### Button-Shaped Batteries

Button-shaped cells, also commonly referred to as coin-shaped cells, are thin compared to their diameter. In a preferred embodiment, the battery is button-shaped with a 9.5 mm diameter and a 2.7 mm height. Preferably, the battery has a nominal voltage in the range of from 2.8 to 4.0 volts, preferably of from 3.0 to 3.8 volts, preferably of from 3.2 to 3.6 volts. More preferably, the battery has a nominal voltage of 3.0 volts, or 3.2, 3.3, 3.4, 3.5 or 3.6. volts, and a capacity for a constant discharge down to 2.0 volts per cell of 30 mAh.

In a preferred embodiment, the battery is button-shaped with a 10 mm diameter and a 2.5 mm height. Preferably, the battery has a nominal voltage of 3.0 volts. More preferably, the battery has a nominal voltage of 3.0 volts and a capacity for a constant discharge down to 2.0 volts per cell of 30 mAh.

In a preferred embodiment, the battery is button-shaped with a 11.5 mm diameter and a 3.0 mm height. Preferably, the battery has a nominal voltage of 3.0 volts. More preferably, the battery has a nominal voltage of 3.0 volts and a capacity for a constant discharge down to 2.0 volts per cell of 70 mAh.

In a preferred embodiment, the battery is button-shaped with a 11 mm diameter and a 10.8 mm height. Preferably, the battery has a nominal voltage of 3.0 volts. More preferably, the battery has a nominal voltage of 3.0 volts and a capacity for a constant discharge down to 2.0 volts per cell of 160 mAh.

In a preferred embodiment, the battery is button-shaped with a 12.5 mm diameter and a 1.6 mm height. Preferably, the battery has a nominal voltage of 3.0 volts. More preferably, the battery has a nominal voltage of 3.0 volts and a capacity for a constant discharge down to 2.0 volts per cell of 25 mAh.

In a preferred embodiment, the battery is button-shaped with a 12.5 mm diameter and a 2.0 mm height. Preferably, the battery has a nominal voltage of 3.0 volts. More preferably, the battery has a nominal voltage of 3.0 volts and a capacity for a constant discharge down to 2.0 volts per cell of from 35 to 40 mAh.

In a preferred embodiment, the battery is button-shaped with a 12.5 mm diameter and a 2.5 mm height. Preferably, the battery has a nominal voltage of 3.0 volts. More preferably, the battery has a nominal voltage of 3.0 volts and a capacity for a constant discharge down to 2.0 volts per cell of 50 mAh.

In a preferred embodiment, the battery is button-shaped with a 16 mm diameter and a 1.6 mm height. Preferably, the battery has a nominal voltage of 3.0 volts. More preferably, the battery has a nominal voltage of 3.0 volts and a capacity for a constant discharge down to 2.0 volts per cell of from 50 to 55 mAh.

In a preferred embodiment, the battery is button-shaped with a 16 mm diameter and a 2.0 mm height. Preferably, the battery has a nominal voltage of 3.0 volts. More preferably, the battery has a nominal voltage of 3.0 volts and a capacity for a constant discharge down to 2.0 volts per cell of from 75 to 78 mAh.

In a preferred embodiment, the battery is button-shaped with a 16 mm diameter and a 3.2 mm height.

Preferably, the battery has a nominal voltage of 3.0 or 3.2, 3.4 or 3.6 volts.

More preferably, the battery has a nominal voltage of 3.0 volts, or 3.2, 3.4 or 3.6 volts, and a capacity for a constant discharge down to 2.0 volts per cell of 140 mAh.

In a preferred embodiment, the battery is button-shaped with a 20 mm diameter and a 1.2 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 55 mAh.

In a preferred embodiment, the battery is button-shaped with a 20 mm diameter and a 1.6 mm height. Preferably, the battery has a nominal voltage of 3.0 volts, or 3.2, 3.4 or 3.6 volts. More preferably, the battery has a nominal voltage of 3.0 volts and a capacity for a constant discharge down to 2.0 volts per cell of 90 mAh. In a preferred embodiment, the battery is button-shaped with a 20 mm diameter and a 2.0 mm height. Preferably, the battery has a nominal voltage of 3.0 volts. More preferably, the battery has a nominal voltage of 3.0 volts, or 3.2, 3.4 or 3.6 volts, and a capacity for a constant discharge down to 2.0 volts per cell of from 115 to 125 mAh.

In a preferred embodiment, the battery is button-shaped with a 20 mm diameter and a 2.5 mm height. Preferably the, the battery has a nominal voltage of 3.0 volts, or 3.2, 3.4 or 3.6 volts. More preferably the, the battery has a nominal voltage of 3.0 volts, or 3.2, 3.4 or 3.6 volts, and a capacity for a constant discharge down to 2.0 volts per cell of from 160 to 165 mAh.

In a preferred embodiment, the battery is button-shaped with a 20 mm diameter and a 3.2 mm height. Preferably the, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 225 mAh.

Preferably, the battery has a maximum discharge current of 3 mA. Preferably, the battery has a maximum pulse discharge current of 15 mA. Preferably, the battery has a mass of less than 3.0 g, more preferably less than 2.9 g, even more preferably of less than 2.8 g.

In a preferable embodiment, the battery is button-shaped with a 20 mm diameter and a 4.0 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 280 mAh.

In a preferable embodiment, the battery is button-shaped with a 23 mm diameter and a 2.0 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 350 mAh.

In a preferable embodiment, the battery is button-shaped with a 23 mm diameter and a 2.0 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of from 110-175 mAh.

In a preferable embodiment, the battery is button-shaped with a 23 mm diameter and a 2.5 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of from 165 to 210 mAh. In a preferred embodiment, the battery is button-shaped with a 23 mm diameter and a 3.0 mm height.

Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 265 mAh.

In a preferable embodiment, the battery is button-shaped with a 23 mm diameter and a 3.5 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 165 mAh.

In a preferable embodiment, the battery is button-shaped with a 23 mm diameter and a 5.4 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 560 mAh. In a preferable embodiment, the battery is button-shaped with a 24 mm diameter and a 1.2 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 100 mAh. In a preferable embodiment, the battery is button-shaped with a 24 mm diameter and a 3.0 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of from 270 to 290 mAh.

In a preferable embodiment, the battery is button-shaped with a 24 mm diameter and a 5.0 mm height. Preferably, the battery has a nominal voltage of 3.0 volts to 3.8 volts, such as 3.2, 3.4 or 3.6 volts,. More preferably, the battery has a nominal voltage of 3.0 or 3.2 volts and a capacity for a constant discharge down to 2.0 volts per cell of from 610 to 620 mAh.

In a preferable embodiment, the battery is button-shaped with a 24 mm diameter and a 7.7 mm height. Preferably, the battery has a nominal voltage of 3.0 volts, or 3.2, 3.4 or 3.6 volts. More preferably, the battery has a nominal voltage of 3.0 volts, or 3.2, 3.4 or 3.6 volts, and a capacity for a constant discharge down to 2.0 volts per cell of 1000 mAh. In a preferable embodiment, the battery is button-shaped with a 26.2 mm diameter and a 1.67 mm height.

In a preferable embodiment, the battery is button-shaped with a 30 mm diameter and a 3.2 mm height.

Preferably, the battery has a nominal voltage of 3.0 volts, or 3.2, 3.4 or 3.6 volts. More preferably, the battery has a nominal voltage of 3.0, or 3.2, 3.4 or 3.6 volts and a capacity for a constant discharge down to 2.0 volts per cell of from 500 to 560 mAh.

In a preferable embodiment, the battery is button-shaped with a 30 mm diameter and a 3.2 mm height. Preferably, the battery has a nominal voltage of 3.0 volts, or 3.2, 3.4 or 3.6 volts. More preferably the battery has a nominal voltage of 3.0 or 3.2, 3.4 or 3.6 volts and a capacity for a constant discharge down to 2.0 volts per cell of from 500 to 560 mAh.

### Flat or Pouch shape

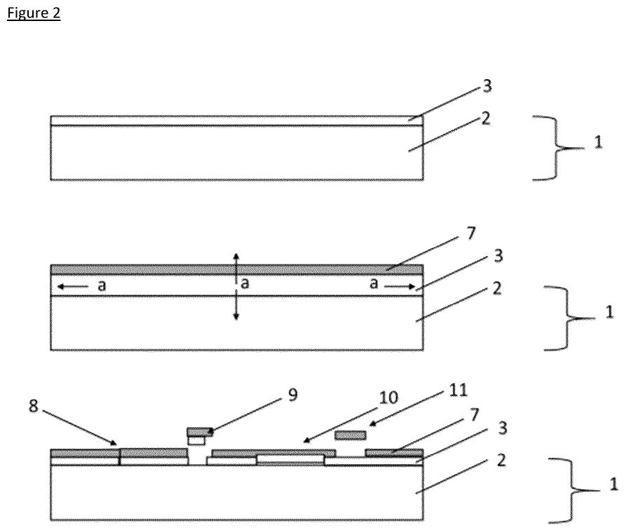

The design of the individual batteries around the high energy positive electrode active material can provide for batteries with a high capacity within a practical format. Pouch batteries are generally approximate rectangular parallelepipeds, excluding the connection tabs and other potential features around the edges, characterized by a thickness (t) and a planar area with a width (w) and a height (h) in which the thickness is generally significantly less than the linear dimensions (width and height) defining the planar area (w·h), as shown schematically in FIG. 2. In particular, the batteries can have a thickness between about 7 mm and about 18 mm. The area of the pouch battery can range from about 25,000 mm 2 to about 50,000 mm2, in which the linear dimensions of width and height defining the area generally range from about 50 mm to about 750 mm.

The resultant individual battery generally can have a discharge energy density of at least about 160 Wh/kg when discharged from 4.5V to 2.0V. In some advantageous embodiments, the resultant battery can have a discharge energy density of at least about 200 Wh/kg, in other embodiments from about 250 Wh/kg to about 400 Wh/kg when discharged from 4.5V to 2.0V. In further embodiments, the battery can have a volumetric discharge energy density of at least about 300 Wh/l. In other advantageous embodiments, the resultant battery can have a volumetric discharge energy density of at least about 500 Wh/l to 1150 Wh/l when discharged from 4.5V to 2.0V.

In the above-described embodiments, prismatic type, cylindrical types, laminate film type, coin type or a button type or and batteries in spirally wound configuration are described. However, the battery according to the invention may be applicable to any other shape, wherein the battery element has any other configuration such as a laminate configuration.

### Use of Cell or Battery According to Any Previous Aspect

An additional aspect of the disclosure is the use of the cell or the battery according to any previous aspect or embodiment of the disclosure above as an energy storage and/or release device.

The term “energy storage and/or release device” herein is understood to mean a secondary battery, including an electrode assembly of a cathode/separator/anode structure mounted in a suitable battery case. Such batteries include lithium-ion secondary batteries, which are excelling in providing high energy density, and a high capacity; and their use in secondary battery modules comprising a plurality of secondary batteries, which are typically connected in series with each other to form a battery pack that can be incorporated into a casing to form the module.

### Specific Electrolyte

In another aspect, the disclosure relates to an electrolyte comprising:
9 to 29 wt. % lithium bis(fluorosulfonyl)imide;
1,2-dimethoxyethane; and
1,1,2,2-tetrafluoroethyl 2,2,3,3-tetrafluoropropyl ether,
the electrolyte having a (lithium bis(fluorosulfonyl)imide): (1,2-dimethoxyethane): (1,1,2,2- tetrafluoroethyl 2,2,3,3- tetrafluoropropyl ether) molar ratio of 1:x:y, where 1.2≤x≤3.0 and 2.0≤y≤4.0.

Preferably, where 1.2≤x≤2.5 and 2.2≤y≤3.8, more preferably where 1.2≤x≤2.0 and 2.4≤y≤3.6, even more preferably where 1.2≤x≤1.8 and 2.8≤y≤3.2, most preferably where x =1.2 and y =3.0.

Without being bound by theory, it is believed that the electrolyte according to the present aspect possess advantageous electrolyte properties, enabling longer cycle life to be obtained for lithium-ion cells comprising such an electrolyte.

### DETAILED DESCRIPTION OF THE FIGURES

The disclosure will now be discussed with reference to the figures, which show preferred exemplary embodiments of the subject disclosure.

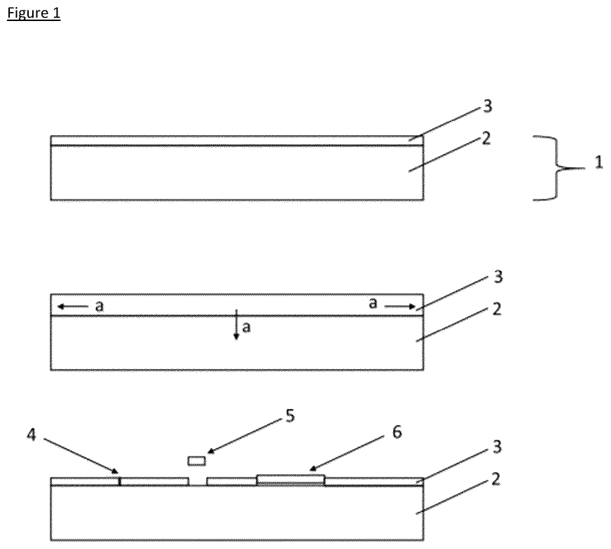

FIG. 1 depicts schematically a traditional silicon anode material in a first un-lithiated state (top), a fully lithiated state (middle) and a fully de-lithiated state (bottom)

FIG. 2 depicts schematically a traditional silicon anode material during SEI formation silicon anode material in a first un-lithiated state (top), a fully lithiated state (middle) and a fully de-lithiated state (bottom).

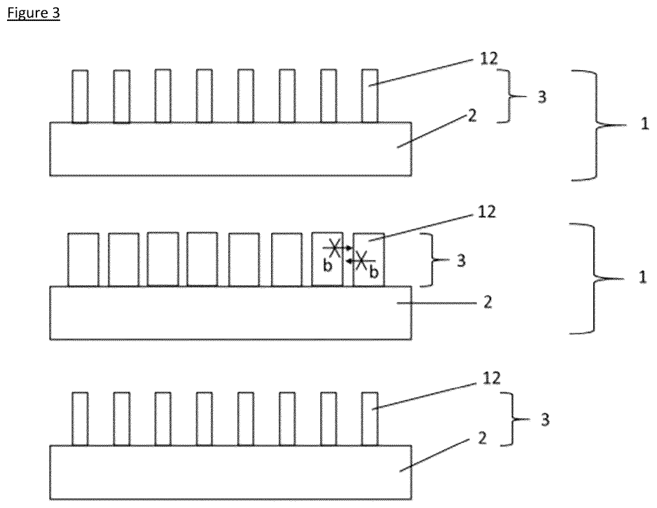

FIG. 3 depicts schematically a silicon anode material in which the silicon layer comprises a plurality of columnar structures on a current collector. It depicts the silicon anode material silicon anode material in a first un-lithiated state (top), a fully lithiated state (middle) and a fully de-lithiated state (bottom).

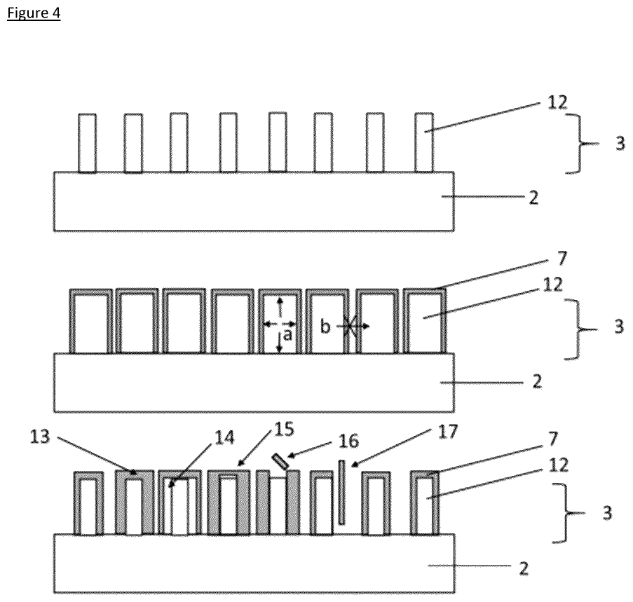

FIG. 4 depicts schematically a silicon anode material in which the silicon layer comprises (i) a plurality of columnar structures on a current collector and (ii) a SEI. It depicts the silicon anode material silicon anode material in a first un-lithiated state (top), a fully lithiated state (middle) and a fully de-lithiated state (bottom).

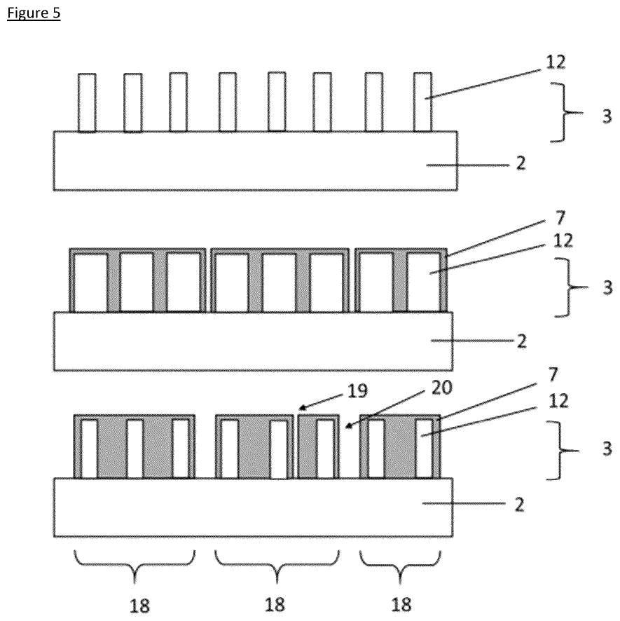

FIG. 5 depicts schematically a silicon anode material in a lithium cell according to the invention. It depicts the silicon anode in a first un-lithiated state (top), a fully lithiated state (middle) and a fully de-lithiated state (bottom).

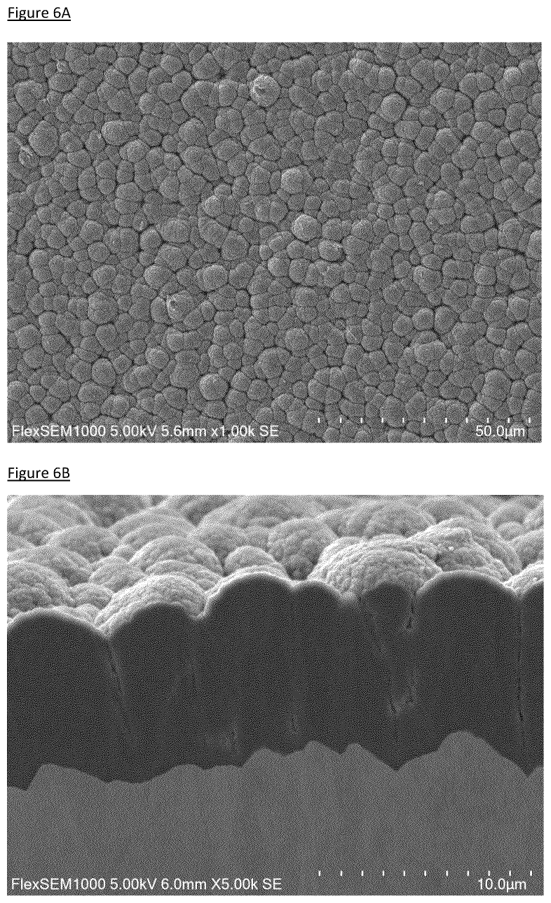

FIG. 6A is a top-down scanning electron microscopy image obtained of an anode comprising a silicon layer in which the silicon layer comprises a plurality of columnar structures.

FIG. 6B is a cross-sectional scanning electron microscopy image obtained of an anode comprising a silicon layer in which the silicon layer comprises a plurality of columnar structures.

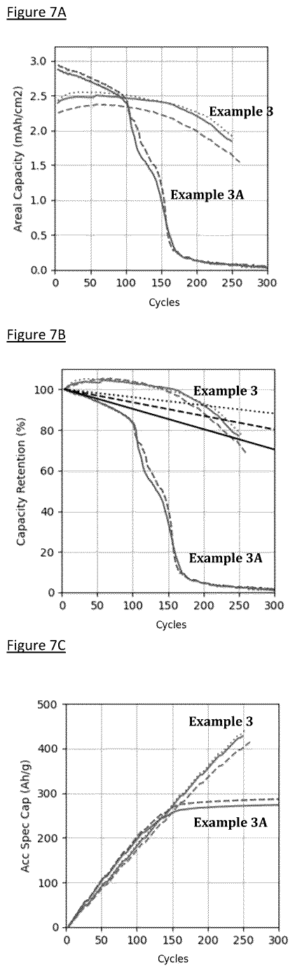

FIG. 7A is graph of areal capacity (mAh/cm²) against cycle number experimentally obtained for a material according to the present disclosure (Example 3) and a comparative example (Example 3A).

FIG. 7B is a graph of capacity retention (%) against cycle number experimentally obtained for a material according to the present disclosure (Example 3) and a comparative example (Example 3A).

FIG. 7C is a graph of accumulated specific capacity (Ah/g) against cycle number experimentally obtained for a material according to the present disclosure (Example 3, straight, solid line) and a comparative example (Example 3A, curved, solid line).

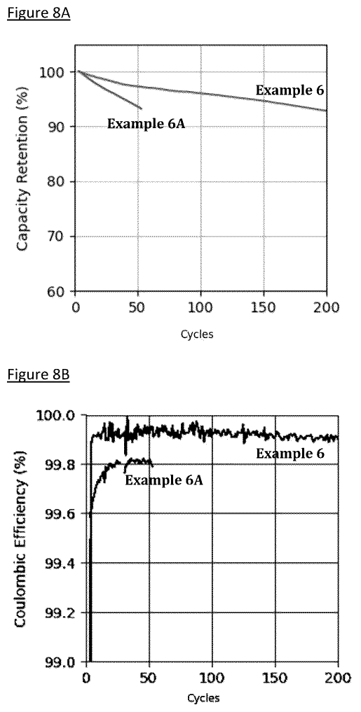

FIG. 8A is a graph of capacity retention (%) against cycle number experimentally obtained for a material according to the present disclosure (Example 6, top line) and a comparative example (Example 6A, curved, solid line).

FIG. 8B is a graph of coulombic efficiency (%) against cycle number experimentally obtained for a material according to the present disclosure (Example 6, top line) and a comparative example (Example 6A, bottom line).

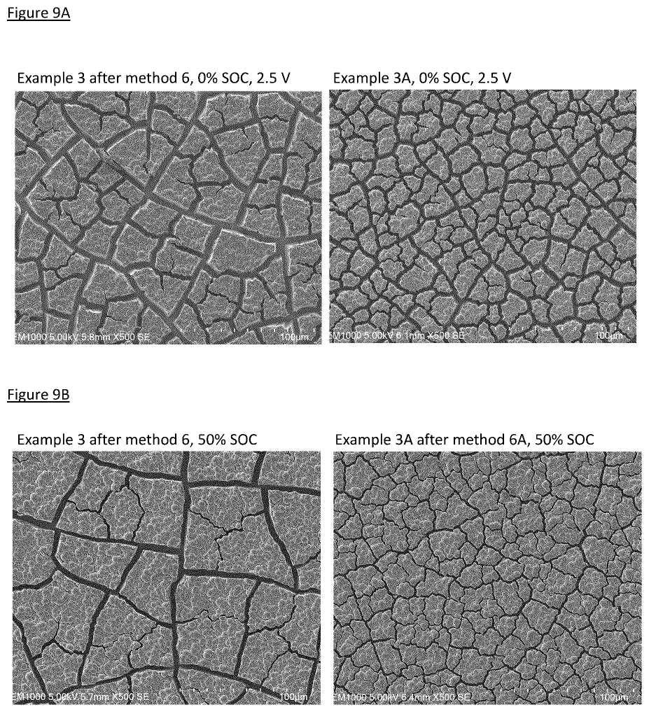

FIG. 9A is a SEM image of the anode surfaces of Example 3 (left) and Comparative Example 3A (right) after performing method 6, at 0% state of charge. As can be seen, the surface morphology of anode of lithium-ion cells according to the present disclosure is significantly different than that of lithium-ion cells made using conventional carbonate-based electrolytes. The surface morphology of both lithium-ion cells according to the present disclosure and those made using conventional carbonate-based electrolytes after the method of Example 6 and 6A have been performed are characterized by islands of columnar silicon separated by cracks. These are visually reminiscent of mud-cracks.

FIG. 9B is a SEM image of the anode surface of Example 3(left) and Comparative Example 3A (right) after performing method 6, at 50% state of charge. As can be seen, the surface morphology of anode of lithium-ion cells according to the present disclosure is significantly different than that of lithium-ion cells made using conventional carbonate-based electrolytes. The surface morphology of both lithium-ion cells according to the present disclosure and those made using conventional carbonate-based electrolytes after the method of Example 6 and 6A have been performed are characterized by islands of columnar silicon separated by cracks. These are visually reminiscent of mud-cracks.

### LIST OF REFERENCE NUMERALS

1 silicon anode.
2 current collector layer.
3 silicon layer.
4 crack in silicon layer
5 ablated silicon (crumbled silicon)
6 delaminated silicon
7 solid electrolyte interphase (SEI) layer
8 crack in both SEI and silicon layer
9 ablated SEI and silicon
10 Delaminated silicon layer
11 ablated SEI
12 columnar structure
13 excessive SEI deposition
14 internal delamination of SEI from wall of columnar structure
15 delamination of SEI from top of columnar structure
16 ablation of SEI from top of columnar structure
17 ablation of SEI from wall of columnar structure
18 islands of columnar structures of silicon connected by SEI
19 secondary void
20 primary void
a direction of force exerted by swelling of silicon.
b direction of in which force exertion is obviated by structure

### EXAMPLES

The following, non-limiting examples illustrate the products and processes according to the disclosure.

### Example 1—Preparation of an Electrolyte Solution According to the Disclosure

The lithium salt Lithium bis(fluorosulfonyl)imide (187 g, 1.0 mole) was added to the non-aqueous solvent 1,2-dimethoxyethane (108 g, 1.2 moles) at 22° C. with continuous stirring. Once all the lithium salt is fully dissolved, the diluent 1,1,2,2-tetrafluoroethyl 2,2,3,3-tetrafluoropropyl ether (696 g, 3.0 moles) was added with further stirring at 22° C. The resultant electrolyte was evaluated and exhibited advantageous electrolyte properties.

### Example 2—Preparation of the Anode Material [Silicon With a Columnar Morphology on the Nanoscale]

A roll of roughened copper foil current collector material (Sa 0.51 μm, Sq 0.65 μm, Sz 5.9 μm, Sds 0.77 μm⁻², Ssc 16.2 μm⁻²,Sdq 2.1 μm, Sdr 157% as determined by standard method ISO 25178) was fed into a plasma enhanced chemical vapour deposition (PECVD) device that comprises an unwinding chamber, two deposition chambers and a rewinding chamber. These chambers are all connected and are normally operated under vacuum (0.05-0.2 mbar). The foil was transported by a system of tension rolls and two heated drums that control the temperature of the foil. A first silicon layer was deposited onto the same side of the copper substrate by PECVD, at a substrate temperature of from 100 to 300° C. In this process magnetron radiation with a frequency of 2.45 GHz was used to excite a gas mixture containing a silicon precursor gas and support gases. Silane (SiH₄) was the source of silicon, whereas argon (Ar) and hydrogen (H₂) were added to stabilize the plasma, influence the material structure and improve the deposition rate. The gas was injected via “gas showers” that distribute the gas evenly.

The magnetron (microwave) radiation was introduced into the vacuum chamber by means of an antenna. To ensure a homogeneous plasma, both sides of the antenna are connected to a magnetron radiation source. Magnetron heads are thus located on each side of the antenna. These magnetron heads are connected to the antenna. Gases are injected via the gas showers proximal to the magnetron heads. The antenna is protected from the reactive environment by a quartz tube. The plasma is confined by a magnetic field that is generated by an array of permanent magnets.

The production rate of silicon was determined by the process conditions, power input per source, and by the number of microwave sources in operation. The gas flow was scaled with the MW power input, which was 800-6000 W/m. Ten antennas or sources of power input were used.

FIG. 6A is top-down Scanning Electron Microscopy (SEM) image of the material obtained. FIG. 6B is a cross-sectional Scanning Electron Microscopy (SEM) image of the material obtained. The bar represents 10 μm and each graduation is equivalent to 1 μm.

Cross-sectional SEM (FIG. 6B) established that the deposited silicon layer had a thickness of from 8 to 9 μm. BET analysis determined that the material had a surface area of 79.9 m²/g a porosity of 15.73% and an average pore size of 4.01 nm. XRF analysis revealed a mass loading of 1.27-1.29 mg/cm². The deposited material had a CIELAB lightness value L* of from 42.07 to 42.98.

### Example 3—Preparation of Pouch Lithium-Ion Cell According to the Disclosure

A pouch cell was built by stacking (i) the anode material as prepared above [Example 2], (ii) a ceramic-coated separator (a 12 μm polymer polypropylene coated on both sides with a 2 μm layer of alumina sourced from Gelon LIB Group, China) and (iii) a cathode material (3.5 mAh/cm² lithium nickel manganese cobalt oxide NMC 622, commercially available from CUSTOMCELLS). Both the cathode and anode were connected to an external circuit by electrode tabs that were welded by conventional means to the electrodes by conventional means. The tabbed and stacked unit was pouched within a commercially available laminated aluminium pouching material, which was sealed on three sides. The electrolyte prepared according to Example 1 was added to the laminated aluminium pouch under a dry atmosphere, and then vacuum sealed.

### Comparative Example 3A—Preparation of Conventional Pouch Lithium-Ion Cell

A pouch cell was built by stacking (i) the anode material as prepared above [Example 2], (ii) as a ceramic separator, a 12 μm polymer polypropylene membrane coated on both sides with a 2 μm layer of alumina was employed, which was sourced from Gelon LIB Group, China; and (iii) as cathode material, a 3.5 mAh/cm² lithium nickel manganese cobalt oxide NMC 622 anode was employed which is commercially available from CUSTOMCELLS. Both the cathode and anode were connected to an external circuit by electrode tabs that were welded by conventional means to the electrodes by conventional means. The tabbed and stacked unit was pouched within a laminated aluminium pouching material, which was sealed on three sides. A commercially available electrolyte was added to the laminated aluminium pouch under a dry atmosphere, and then vacuum sealed. The commercially sourced electrolyte was a solution of LiPF₆ (1 M), in a mixture of 1,3-dioxolan-2-one (ethylene carbonate, EC) and diethyl carbonate (DEC) in a 1:1 volumetric ratio, which additionally contained 5 wt. % of fluoroethylene carbonate, 2 wt. % of vinylene carbonate and 2 wt. % adiponitrile (AN).

### Example 4—Cycle Life/Capacity Retention Analysis

Cells according to the disclosure prepared according to Example 3 and comparative cells prepared according to Example 3A were evaluated for their capacity retention properties. The cycling conditions used were C/2 rate, 3 V to 4.2 V (Constant Voltage [CV] step at 4.2 V until C/20 rate) at 25° C.

The results are presented in FIGS. 7A, 7B and 7C.
The results demonstrated that lithium-ion cells according to the disclosure demonstrated that lithium-ion cells according to the present disclosure:
retained high areal capacity for significantly more charge cycles than the comparative examples;
retained high capacity retention for significantly more charge cycles that the comparative examples; and
retained a substantially linear accumulated specific capacity relationship for significantly more charge cycles, and retained a higher accumulated specific capacity until 80% beginning of life capacity.
   Thus, lithium-ion cells according to the present disclosure demonstrate improved capacity retention, and hence cycle-life, compared to lithium-ion cells made using conventional carbonate-based electrolytes. The number of cycles required for the accumulated specific capacity, which in this instance is a measure of how much capacity is delivered normalised to the mass of silicon, before capacity falls to 80% of the beginning-of-life capacity is approximately twice as high for lithium-ion cells according to the present disclosure that for lithium-ion cells made using conventional carbonate-based electrolytes.

### Example 5—Cycle Life/Capacity Retention Analysis Without Constant Voltage Step

Lithium-ion cells according to the disclosure prepared according to Example 3 and comparative lithium-ion cells prepared according to Example 3A were evaluated for their capacity retention properties.
The cycling conditions used were C/2 rate, 3 V to 4.2 V at 25° C.
The results are presented in FIG. 8A. As can be seen from FIG. 8A, lithium-ion cells according to the disclosure can undergo approximately 200 cycles before capacity retention falls to 93%, whereas lithium-ion cells made using conventional carbonate-based electrolytes can only undergo approximately 50 cycles before capacity retention falls to 93%. FIG. 8B shows that lithium-ion cells according to the disclosure achieve higher coulombic efficiency (>99.9%), whereas lithium-ion cells made using conventional carbonate-based electrolytes only achieve a maximum of 99.8%.
The results demonstrated that lithium-ion cells according to the disclosure:
demonstrated superior capacity retention than lithium-ion cells made using conventional carbonate-based electrolytes; and
possess higher coulombic efficiency (approximately >99.9%) than lithium-ion cells made using conventional carbonate-based electrolytes (approximately 99.8%).
   The higher coulombic efficiency is indicative that lithium-ion cells according to the present disclosure undergo less side reactions and lithium inventory loss than lithium-ion cells made using conventional carbonate-based electrolytes.

### Example 6—Solid Electrolyte Interphase Formation Method According to the Disclosure

Lithium-ion cells were prepared according to Example 3 and underwent the following steps:
rested for 1 hour;
0.01 C charge for 10 hours;
0.1 C charge for either (i) 9 hours or (ii) until reaching 4.2 V;
Rested for 30 minutes;
0.1 C discharge until reaching 2.5 V;
Rest 30 minutes;
0.2 C charge until reaching 4.2 V;
Rest 30 minutes;
0.2 C discharge until reaching 2.5 V;
Rest 30 minutes.
   The solid electrolyte interphase was formed during formation of lithium-ion cells held within pressure clamps (~350 psi at initial state).

### Comparative Example 6A—Solid Electrolyte Interphase Formation Method According to the Disclosure

Lithium-ion cells were prepared according to Example 3A and underwent the following steps:
rested for 1 hour;
0.01 C charge for 10 hours;
0.1 C charge for either: (i) 9 hours or (ii) until reaching 4.2 V;
Rested for 30 minutes;
0.1 C discharge until reaching 2.5 V;
Rest 30 minutes;
0.2 C charge until reaching 4.2 V;
Rest 30 minutes;
0.2 C discharge until reaching 2.5 V;
Rest 30 minutes.
   The solid electrolyte interphase was formed in lithium-ion cells held within pressure clamps (~350 psi at initial state).

### Example 7—Analysis of Anode Surface Morphology After Charge Cycling and Complete Discharge

Lithium-ion cells according to the disclosure prepared according to Example 3 and comparative lithium-ion cells prepared according to Example 3A were evaluated for their morphological properties after formation (full cycles ending in discharged state).
The cycling conditions used were those of Example 6A, finishing at 2.5 V and 0% state of charge (SOC).
The lithium-ion cells were then disassembled under inert conditions and analysed by Scanning Electron Microscopy (SEM). Representative SEM images are reproduced in FIG. 9A. As can be seen, the surface morphology of anode of lithium-ion cells according to the present disclosure is significantly different than that of lithium-ion cells made using conventional carbonate-based electrolytes. The surface morphology of both lithium-ion cells according to the present disclosure and those made using conventional carbonate-based electrolytes after the method of Example 6 and 6A have been performed are characterized by islands of columnar silicon separated by cracks. These are visually reminiscent of mud-cracks.
The surface morphology of lithium-ion cells according to the present disclosure unexpectedly differ from those made using conventional carbonate-based electrolytes, after the method of Example 6 or Comparative Example 6A have been performed, in that the crack density is significantly lower, the islands are significantly larger and the cracks significantly wider.
The exact mechanism that allows morphological control of the anode surface by the electrolyte of the present disclosure is unknown.
Without being bound by theory, it is believed that lithium-ion cells that exhibit a surface morphology characterized by lower crack density, large islands and wider cracks unexpectedly allow for lower surface area, therefore less parasitic decomposition of electrolytes, therefore less solid electrolyte interphase formation and consequently contribute to higher cycle-life of such lithium-ion cells.

### Example 8—Analysis of Anode Surface Morphology After Charge Cycling and Partial Charge

Lithium-ion cells according to the disclosure prepared according to Example 3 and comparative lithium-ion cells prepared according to Example 3A were evaluated for their capacity retention properties.

### The Cycling Conditions Used Were As Follows:

rested for 1 hour;
0.01 C charge for 10 hours;
0.1 C charge for either: (i) 9 hours or (ii) until reaching 4.2 V;
Rested for 30 minutes;
0.1 C discharge until reaching 2.5 V;
Rest 30 minutes;
0.2 C charge until reaching 4.2 V;
Rest 30 minutes;
0.2 C discharge until reaching 2.5 V;
   finishing at 2.5 V
Rest 30 minutes
   0.2 C charge until 50% state of charge (SOC).
   The lithium-ion cells were then disassembled under inert conditions and analysed by Scanning Electron Microscopy (SEM). Representative SEM images are reproduced in FIG. 9B. As can be seen, the surface morphology of anode of lithium-ion cells according to the present disclosure is significantly different than that of lithium-ion cells made using conventional carbonate-based electrolytes. The surface morphology of both lithium-ion cells according to the present disclosure and those made using conventional carbonate-based electrolytes after the methods outlined above have been performed are characterized by islands of columnar silicon separated by voids (cracks). These are visually reminiscent of mud-cracks.
   The surface morphology of lithium-ion cells according to the present disclosure unexpectedly differ from those made using conventional carbonate-based electrolytes, after the methods outlined above have been performed, in that the void (crack) density is significantly lower, the islands are significantly larger and the voids (cracks) significantly wider.

The exact mechanism that allows morphological control of the anode surface by the electrolyte of the present disclosure is unknown.

Without being bound by theory, it is believed that lithium-ion cells that exhibit a surface morphology characterized by lower void (crack) density, large islands and wider void (cracks) unexpectedly allow for lower surface area, therefore less parasitic decomposition of electrolytes, therefore less solid electrolyte interphase formation and consequently increasing the cycle-life of such lithium-ion cells.

1. A lithium-ion cell comprising:
a silicon anode, the silicon anode comprising:
i. a current collector layer; and
ii. a silicon layer,
wherein the silicon layer comprises a plurality of columnar structures on a current collector;
a cathode;
a separator; and
an electrolyte, the electrolyte comprising:
i. 9 to 29 wt. %, with respect to the electrolyte, of a lithium salt;
ii. a non-aqueous solvent; and
iii. a diluent,
wherein the electrolyte having a lithium salt-solvent-diluent molar ratio of 1:x:y, where 1.0≤x≤3.0 and 2.0≤y≤4.0.

2. The lithium-ion cell according to claim 1, in which the silicon layer has a depth of from 1 to 200 μm.

3. The lithium-ion cell according to claim wherein the silicon layer comprises:
i. a plurality of columnar structures on a current collector, the columnar structures predominantly extending in a perpendicular direction from the current collector layer surface; and
ii. primary voids having a width of from 1 to 10 μm.

4. The lithium-ion cell according to claim 1, wherein the electrolyte has a lithium salt-solvent-diluent molar ratio of 1:x:y, where 1.1≤x≤2.5 and 2.2≤y≤3.8.

5. The lithium-ion cell according to claim 1, in which the lithium salt is lithium bis(fluorosulfonyl)imide.

6. The lithium-ion cell according to claim 1, in which:
i. the non-aqueous solvent is 1,2-dimethoxyethane.

7. The lithium-ion cell according to claim 1, in which:
i. the diluent is 1,1,2,2-tetrafluoroethyl 2,2,3,3-tetrafluoropropyl ether.

8. The lithium-ion cell according to claim 1, in which the silicon layer has a porosity of from 0% to 80%, as determined by the BJH method of ISO 15901-2:2006.

9. The lithium-ion cell according to claim 1, wherein the cell is obtainable by a process comprising the following steps, in the following order:
(i) providing of the lithium-ion cell claims;
(ii) charging the cell to at least 4.0 V;
(iii) discharging the cell to 3.0 V.

10. The lithium-ion cell according to claim 1,
wherein the cell is obtainable by a process comprising the following steps in the following order:
(i) providing the lithium-ion cell;
(ii) charging at 0.01 C for 10 hours;
(iii) charging at 0.1 C for either (i) 9 hours or (ii) until reaching 4.2 V;
(iv) discharging at 0.1 C until reaching 2.5 V;
(v) charging at 0.2 C until reaching 4.2 V;
(vi) discharging at 0.2 C until reaching 2.5 V;
(vii) charging at 0.2 C for 90 minutes.

11. A lithium-ion cell comprising:
a silicon anode, the silicon anode comprising:
i. a current collector layer;
ii. a silicon layer on the current collector layer; and
iii. solid electrolyte interphase layer,
where the silicon layer comprises
a plurality of columnar structures on a current collector, the columnar structures predominantly extending in a perpendicular direction from the current collector layer surface;
a cathode;
a separator; and
an electrolyte comprising:
i. a lithium salt;
ii. a non-aqueous solvent; and
iii. a diluent.

12. The lithium-ion cell according to preceding claim 11, wherein the lithium-ion cell is operable at a voltage of from 2.5 V to 4.6 V, more preferably of

13. A battery comprising a lithium-ion cell according to claim 11.

14. Use of a lithium-ion cell according to any of claim 11 as an energy storage device.

15. (canceled)

16. A method of making a lithium-ion cell comprising the steps of:
(i) providing of a lithium-ion cell where the lithium-ion cell comprises:
a silicon anode, the silicon anode comprising:
iii. a current collector layer; and
iv. a silicon layer,
wherein the silicon layer comprises a plurality of columnar structures on a current collector;
a cathode;
a separator; and
an electrolyte, the electrolyte comprising:
iv. 9 to 29 wt. %, with respect to the electrolyte, of a lithium salt;
v. a non-aqueous solvent; and
vi. a diluent,
wherein the electrolyte having a lithium salt-solvent-diluent molar ratio of 1:x:y, where 1.0≤x≤3.0 and 2.0≤y≤4.0;
(ii) charging the lithium-ion cell to at least 4.0 V;
(iii) discharging the lithium-ion cell to 3.0 V.

17. A method of making a lithium-ion cell comprising providing a lithium-ion cell comprising:
a silicon anode, the silicon anode comprising:
i. a current collector layer; and
ii. a silicon layer,
wherein the silicon layer comprises a plurality of columnar structures on a current collector;
cathode;
a separator; and
an electrolyte, the electrolyte comprising:
iii. 9 to 29 wt. %, with respect to the electrolyte, of a lithium salt;
iv. non-aqueous solvent; and
v. a diluent,
wherein the electrolyte having a lithium salt-solvent-diluent molar ratio of 1:x:y, where 1.0≤x≤3.0 and 2.0≤y≤4.0;
wherein the method further comprises:
a. charging the lithium-ion cell at 0.01 C for 10 hours;
b. charging the lithium-ion cell at 0.1 C for either (i) 9 hours or (ii) until reaching 4.2 V;
c. discharging the lithium-ion cell at 0.1 C until reaching 2.5 V;
d. charging the lithium-ion cell at 0.2 C until reaching 4.2 V;
e. discharging the lithium-ion cell at 0.2 C until reaching 2.5 V;
f. charging the lithium-ion cell at 0.2 C for 90 minutes.
